(19) United States
(12) Patent Application Publication
(10) Pub. No.: US 2021/0232577 A1
(43) Pub. Date: Jul. 29, 2021

(54) DEVICES AND SYSTEMS FOR HUMAN CREATIVITY CO-COMPUTING, AND RELATED METHODS

(71) Applicant: FACET LABS, LLC, LOS GATOS, CA (US)

(72) Inventors: Stuart OGAWA, Los Gatos, CA (US); Lindsay SPARKS, Seattle, WA (US); Koichi NISHIMURA, San Jose, CA (US); Wilfred P. SO, Mississauga (CA)

(21) Appl. No.: 17/050,869

(22) PCT Filed: Apr. 25, 2019
(86) PCT No.: PCT/US19/29156

§ 371 Date: Oct. 27, 2020

Related U.S. Application Data
(60) Provisional application No. 62/663,463, filed on Apr. 27, 2018.

(51) Int. Cl. G06F 16/242; G06F 16/248; G06F 3/01; G06F 3/16; G06K 9/00

(52) U.S. Cl. CPC G06F 16/2423; G06F 16/248; G06F 3/015; G06K 9/00302; G06F 3/012; G06K 9/00335; G06F 3/16

(57) ABSTRACT

Devices, systems and computing processes are provided that can ingest human creativity using human inputs (e.g. oral data, text, pictures, musical riffs, white board drawings, gestures, dances, haptic inputs, brain waves, biological inputs, etc.), process and organize these creative inputs using data science, perform real time, autonomous searching, apply data science to search results for supporting and contrasting results related to each topic, subtopic, etc., and provide results and recommendations to the human in real time. As a result, the human is not encumbered with the labor and time intensive research that might already be answered, solved, experimented, written, painted, etc. These efficient tools eliminate research time so that the person focuses on unique theories, thought works, and new artistic works (e.g. what humans do very well). Furthermore, contextually relevant “shadow results” are presented or outputted to the user, which spurs more creative ideas and thoughts.

### CROSS-REFERENCE TO RELATED APPLICATIONS

This patent application claims priority to U.S. Provisional patent Application No. 62/663,463 filed on Apr. 27, 2018 and titled “Devices and Systems for Human Creativity Co-Computing, And Related Methods”, the entire contents of which are herein incorporated by reference.

### TECHNICAL FIELD

The following generally relates to interactive devices and related computing architectures and methods for augmenting human creativity.

### DESCRIPTION OF THE RELATED ART

It is very difficult for an artist, musician, researcher, scientist etc. to imagine, create, explore, and experiment their own work and concurrently keep up to date with contextually relevant information results from peers as well as research historical information from other time periods and genres.

Instead, people typically research ideas and information for inspiration. At a later and separate time, they then think about different ideas and arrive at innovative and creative solutions, approaches, art work, etc.

People research ideas and information using various tools, including digital and non-digital tools. For example, they conduct web searches using internet search engines like Google, Bing, etc. They speak with people and manually record notes, or type notes into a computer. They visit different places (e.g. museums, galleries, facilities) and may make written notes and take photographs with a camera. People may review online journals. People may also review their old notes and old schematics, etc., whether this information is in a digital format or in a paper form.

After researching, people then proceed to consider their goals and their researched information, in order to attempt to innovate and create. This may include “looking back” at their researched information.

The existing tools make the creative process slow and ineffective. The tools themselves are often limited to the user's input (e.g. typed in search queries into a search engine, their notes, their photographs, etc.). The existing tools also make it very difficult for people to search and consume their digital data and their non-digital information (e.g. drawings, prototypes, written notes, etc.) in the context of the creative process or the innovation process. An internet search engine used for research could even slow down or derail the creative process, since too much information is provided or irrelevant information is provided, or both. Even the current searching process (e.g. opening a web browser, thinking of keywords to type into an internet search engine, reviewing links to the search results, clicking on a link, and reviewing the loaded web page of that link) takes cognitive effort and many user-input steps, which disrupts the user's creative process. Furthermore, the disparate tools could lead people to unwittingly research the same things over again, or could lead people to inadvertently research a limited range of ideas.

These and other technical challenges lead to ineffective usage of technology in the human creativity process or the human innovation process.

### BRIEF DESCRIPTION OF THE DRAWINGS

Embodiments will now be described by way of example only with reference to the appended drawings wherein:

FIG. 1 is a schematic diagram of user devices in different human creativity co-computing scenarios. The user devices are in communication with a data enablement platform, which uses machine learning to output data for augmenting human creativity.

FIG. 2 is a schematic diagram of a user painting a picture, and user devices monitoring the user and the picture to output feedback data.

FIG. 3 is a schematic diagram of various user devices, including devices that project images, wearable devices, human-computer interface devices, and a 3D printer. These various user devices are in data communication with the data enablement platform and together are used to output feedback data to augment human creativity.

FIG. 4 is a schematic diagram of cameras and a user device mounted above a group of users. The cameras and other sensors are used to monitor the users and the user device outputs feedback data to augment human creativity.

FIG. 5 is a schematic diagram of a computing architecture that includes a template library for different creative domains, and a selection bot to select an appropriate creative domain template for a given user.

FIGS. 6 and 7 are flow diagrams of computer or processor executable instructions and related components for interacting with a person to output feedback data for augmenting human creativity.

FIG. 8 is a flow diagram of computer of processor executable instructions and related components for processing data from multiple devices, concurrently recording human behavior data, and storing the data in association with each other.

FIG. 9 is a flow diagram of computer or processor executable instructions and related components for autonomously conducting queries in real time based on obtained data (e.g. intentional inputs, sensor data, human behavior data, environment data, etc.).

FIG. 10 is a schematic diagram of different user contexts, including users interacting with different devices in different environments to augment human creativity.

FIG. 11 is a flow diagram of computer or processor executable instructions for producing synesthesia outputs based on the search results.

FIG. 12 is a flow diagram of computer or processor executable instructions for outputting feedback data to a user in response to detecting a user's focused state from obtained human behavior data.

FIG. 13 is a flow diagram of computer or processor executable instructions for biasing queries according to certain conditions of the user detected from obtained human behavior data.

FIG. 14 is an example computing architecture of a data enablement platform for ingesting user data via user devices, and providing big data computations and machine learning.

FIG. 15 is another schematic diagram, showing another example representation of the computing architecture in FIG. 14.

FIG. 16 is a schematic diagram of an example embodiment of a user device, herein referred to as an oral communication device (OCD).

FIG. 17 is a schematic diagram showing an example computing architecture for the data enablement platform.

FIG. 18 is a schematic diagram showing different personalized search bots and respective work files, according to an example embodiment.

FIG. 19 is a schematic diagram showing different derivative work files that are data linked to each other as the user moves forward and backward using a controller along different paths of thinking.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It is herein recognized that it is very difficult for people to research ideas for inspiration and enablement, while concurrently creating or innovating. Attempting to do both (e.g. working on current creative project while also keeping apprised of current and historical information that is contextually relevant) is very labor and time intensive work. Time spent researching what has been done comes at the expense of working on new creative works. These labor and time costs are amplified when the researcher and artist create and imagine a derivative work(s) and or adds an orthogonal dimension to the original idea. This new derivative or orthogonal dimension causes the researcher and artist to go back re-research contextually relevant information. This negatively impacts researchers, scientists, musicians, and artists; they spend too much time researching and reading what has been done and not enough time thinking about what can be done that has not been previously been done. As noted above, the existing tools are slow and ineffective in the creativity process.

Therefore, devices, systems and computing processes are described herein that can keep up with how fast a human can imagine, create, test, fail, learn, and repeat. Humans have the uncanny ability to imagine, create, and experience unlikely or improbable outcomes, which do not necessarily have patterns that a computer can create and perform. This unique human capability is herein called human experiential processing (HEP).

A creative and imaginative person collectively draws upon HEP, such as personal experiences, experimentation, and history (e.g. for inspiration, thought work, experiences, existing solutions to problems, etc.), in order to create new and unique thought work, artistic work, invent technologies, posit theories, problem solving, etc. The devices, systems and computing processes described herein interact with people to help them facilitate HEP. It will be appreciated that the terms “user”, “person” and “human” are herein interchangeably used.

In an example embodiment, devices, systems and computing processes are provided that “shadows and does not interrupt” the user, in real time, capturing the user's imagination and creativity works. The technology described herein provides real time “shadowed feedback” that is responsive to and interactive with human thought work without interrupting the user. This is a symbiotic relationship where the human inputs data/information without actively thinking about the process of entering data/information in a logical process or form. Furthermore, the symbiotic relationship provides the user with information and data in the form and time that the user desires such that the received information does not disrupt the user's imagination and creativity. Hence there is minimal or little mental engagement and effort that the human has to perform about researching. Yet, the system and method capture this data and metadata while the person focuses on the creative project at hand.

In an example embodiment, devices, systems and computing processes are provided that can ingest human creativity using human inputs (e.g. oral data, text, pictures, musical riffs, white board drawings, gestures, dances, haptic inputs, brain waves, biological inputs, etc.), process and organize these creative inputs using data science, perform real time, autonomous searching, apply data science to search results for supporting and contrasting results related to each topic, subtopic, etc., and provide results and recommendations to the human in real time. As a result, the human is not encumbered with the labor and time intensive research that might already be answered, solved, experimented, written, painted, etc. These efficient tools eliminate research time so that the person focuses on unique theories, thought works, and new artistic works (e.g. what humans do very well). Furthermore, contextually relevant “shadow results” are presented or outputted to the user, which spurs more creative ideas and thoughts.

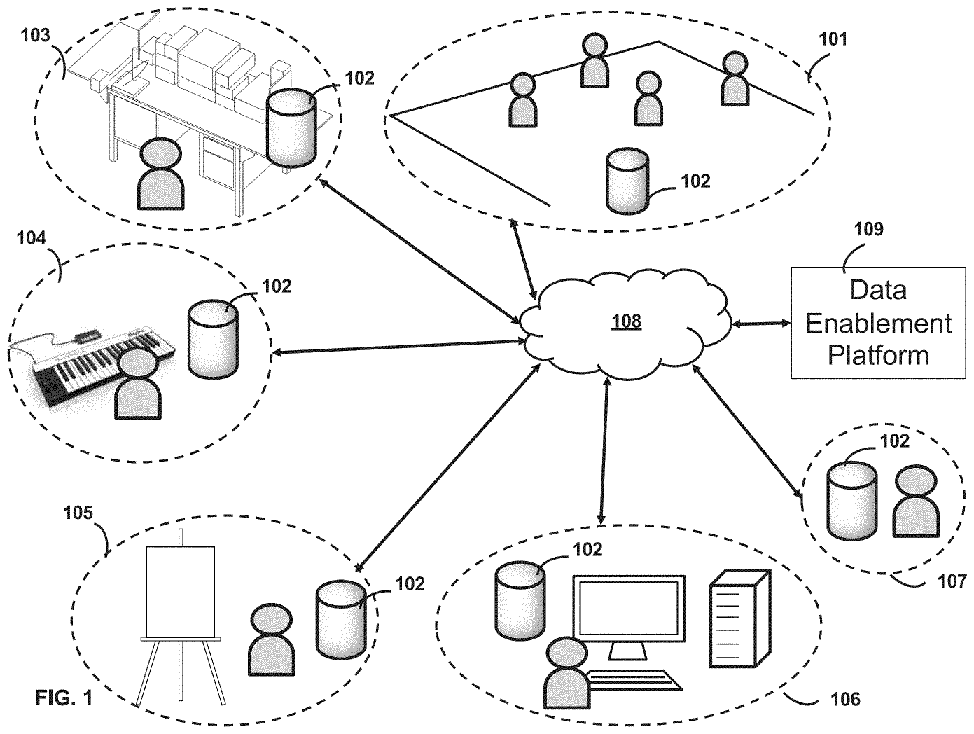

Turning to FIG. 1, different creativity or innovation scenarios 101, 103, 104, 105, 106 and 107 are shown, which each include a user device 102 for interacting with one or more users. The user device 102 includes electronic hardware components for processing data, data communication and for outputting data. In a preferred example embodiment, although not necessarily, the user device includes input devices. Alternatively, the user device 102 is able to communicate with one more other devices (e.g. Internet of Things (loT) devices) to obtain input data. It will be appreciated that one or multiple devices (e.g. multiple the user devices 102, various types of different devices, non-user devices, etc.) can be used in each scenario. The one or multiple devices in each scenario can transmit data amongst each other, transmit data directly to a data enable platform 109 via the data network 108, transmit data indirectly to the data enablement platform 109 via the data network 108, or a combination thereof.

The other devices that interact with the user device 102 (not shown in FIG. 1), or that are part of the user device 102, are various, and examples of these devices include one or more of: cameras, microphones, pressure sensors, satellite-based sensors, LiDAR sensors, temperature sensors, bio-related sensors (e.g. for measuring biometric data like body temperature, heart rate, perspiration, muscle signals, blood flow, blood pressure, finger prints, etc.), brain-computer interface (BCI) devices, RADAR sensors, inertial measurement unit (IMU) sensors, infrared sensors, electro-mechanical sensors, robotic actuators, 3D printers, manufacturing devices, augmented reality devices, immersive virtual reality devices, haptic devices, electro-mechanical devices, multimedia projectors, digital devices, etc. It is appreciated that BCI devices are able to detect one or more of brain signals, nervous system signals, muscle signals, and the like. Some BCI devices are able to affect the brain signals, nervous system signals, muscle signals, and the like. Currently known and future known BCI devices are applicable to the principles described herein. These devices, including the user device, are also herein called user edge devices or edge nodes.

In an example scenario 101, multiple users collaborate to innovate or create, or both. The one or more devices in the scenario 101 monitor the users and provides feedback data to help them innovate and create. This group setting of users could be in various examples, such as creating or innovating upon: a dance, a theatrical play, a maneuver in warfare, a group collaboration on a technology, a group collaboration on a project, etc. The outputted feedback data, for example, can be in the form of audio data, visual data on a display screen, projected multimedia data, human or brain interfacing data, IoT device action data, etc., or a combination thereof.

In an example scenario 103, a user works with technology to build, develop, create new technology (e.g. physical process, physical system or device, digital process, or a combination thereof). The one or more devices 102 monitor the user and the workstation (e.g. the lab bench, the machine workshop, the digital lab, etc.) and provides feedback to the user to help them innovate and create. The outputted feedback data, for example, can be in the form of audio data, visual data on a display screen, projected multimedia data, human or brain interfacing data, IoT device action data, manufacturing device action data, or a combination thereof. For example, feedback data is presented in an audio form, or via images, or via video. Visual data is overlaid real objects in the workstation via a multimedia projector, or via augmented reality devices (e.g. augmented reality glasses or goggles, wearable headsets, eye contacts, etc.). The user edge devices also include, for example, manufacturing devices (like a 3D printer) that automatically manufacture a physical object, which is a form of feedback data; this helps to spur on creative ideas for the user.

In an example scenario 104, a user uses a musical instrument (e.g. an electric keyboard, or some other musical generating device) to compose, play, or edit/produce music. The one or more devices could include the user device 102 and the musical instrument itself, as many musical instruments are electronic or have electronic components. Data about the user, or the music, or both, are monitored and used to provide feedback to the user to help them innovate and create. It is appreciated that the musical instrument or device could be a computing device (e.g. a laptop, a desktop, a mixing board, electronic DJ equipment with jog wheels, etc.) that generates or produces music. For example, the data enablement platform detects that the user's mood and that the user is playing or producing a certain genre of music, and user device 102 outputs audio data or visual data that prompts the user to think of other ideas (e.g. cultural themes, related moods, other riffs or musical segments, etc.).

In an example scenario 105, a user draws or paints. The one or more user devices monitor the user or the picture being made by the user, or both, and then provides feedback data to inspire or prompt the user to think more creatively.

In an example scenario 106, a user uses a computer (e.g. a desktop computer, a laptop, etc.) to create a digital work (e.g. writing, multimedia work, a visual rendering, software code, a schematic, a presentation, etc.). The computer, or the user device 102, or both, monitor the user, or the digital work creating process, or both. This monitored information is then used by the data enablement platform 109 to generate and provide feedback to the user to inspire or prompt the user to think more creatively.

In another example scenario 107, a user interacts with the user device 102 without any particular context. For example, the user talks with the user device to develop thought works, ideas, etc. In turn, the user device (and optionally other devices) monitors the user and provides feedback to the user to inspire or prompt the user to think more creatively.

In an example embodiment, the different scenarios in FIG. 1 include a different user in each scenario, and the data enablement platform is configured to track and to interact with each of these different users.

In an alternative example embodiment, the user is the same in each of the different scenarios, and the data enablement platform tracks the user in these different scenarios. The data enablement platform provides suggestions and data in a given scenario based on data that was previously obtained in one or more different scenarios involving the same user. For example, the data enablement platform 109 obtains data about a given user in scenario 101 (e.g. what the given user said or did, or what other users said or did in the group). When the same given user is in scenario 103, the data enablement platform outputs data (e.g. suggestions, information, prompts, etc.) that include data from, or that are derived from, the data previously obtained in the scenario 101.

It will be appreciated that the data enablement platform 109 includes one or more server machines that can execute queries, store data, and process big data.

The data enablement platform 109 can access and process various types of data including data provided by Internet search engines, data stored in private databases, text data, image data, video data, audio data, brain data, IoT data, biometric data, machine-to-machine data, data originating from animals, data originating from plant life, data originating from weather, data originating from geology, data originating from natural environments, data originating from robots, data originating from machines, data originating from non-human organisms, etc. These various types of data can inspire a person to think of creative works from a different perspective. For example, IoT devices that measure the movement of animals or robots can inspire a person build devices that mimic these recorded movements.

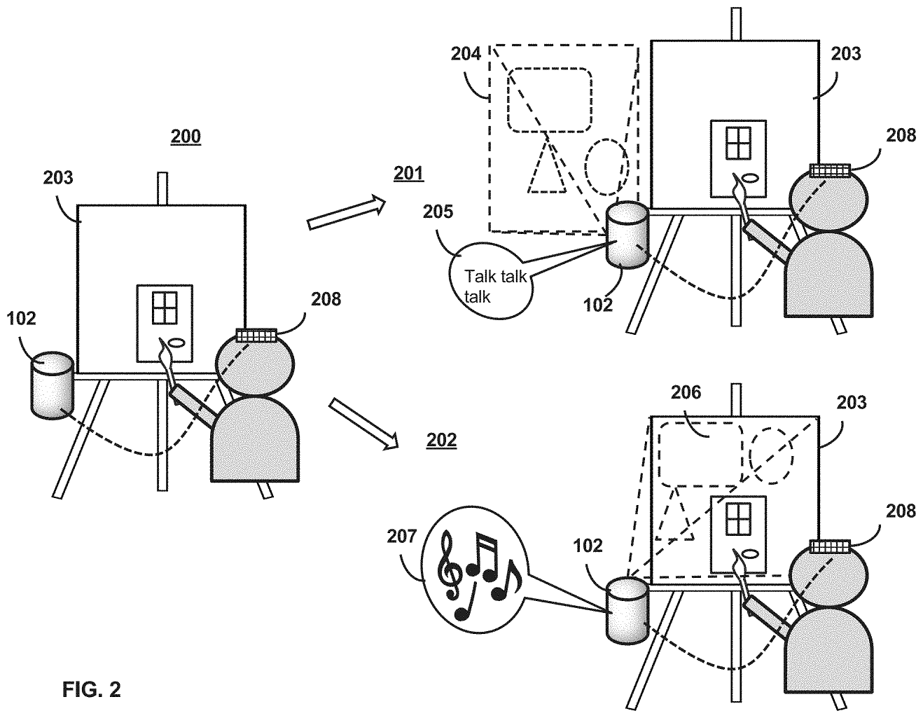

FIG. 2 shows a detailed example embodiment of scenario 105. In an earlier state 200, a user is equipped with a brain computer interface (BCI) device 208 that measures brain signals from the user. The BCI device 208, for example, can also emit energy (e.g. light waves, electrical energy, sound energy, mechanical energy, etc.) to affect the brain. The BCI device 208 and the user device 102 are in data communication with each other (e.g. wireless communication). The user draws or paints on the canvas 203 and, at the same time: the BCI device 208 records the user's brainwaves; the user device 102 uses one or more cameras to record what is being drawn; the user device 102, or another device, records the gestures, facial expressions, body posture, or movements of the user (or a combination thereof); or a combination thereof. These different types of recorded data are marked with timestamps, and based on the timestamps, these different types of data are mapped to each other. For example, at the time stamp t1 there is a first grouping of data; at the time stamp t2 there is a second grouping of data; and so forth for subsequent time stamps. This data is used by the data enablement platform 109 to conduct searches for other data that could facilitate the user's creativity.

For example, the user is drawing a door for a building on the canvas 203. Feedback data could include visual data or audio data, or both, of: other doors (e.g. car doors, doors for cupboards, bank vault doors, aircraft doors, doors on spacecraft, doors on submarines); different buildings that relate to the drawn door (e.g. houses, commercial buildings, etc.); walkways and porches that could match the drawn door; the building process of building a house/building that includes such a door; cultural themes and information relevant to the era or style of the drawn door (e.g. a Victorian style door leads to Victorian cultural themes and information, while a Japanese style door leads to Japanese cultural themes and information); or a combination thereof.

The obtained user data could be used to detect the mood of the user. The user's mood could be used to bias the queries, or to post-process the visual data and/or the audio data, or both. For example, if the user is happy, then a search for bright images and whimsical images is executed, or the resulting images from the query are post-processed to be bright in color or re-represented to be whimsical. In another example, if the user is angry or upset, audio data (e.g. noises, people talking, music, etc.) are selected or post-processed to be reflect the person's mood. For example, fast-tempo music with strong beats are played, or in another example, angry discussions or people yelling are played.

The obtained user data and the content of what is being drawn could also be used to affect the BCI device 208. In other words, the BCI device 208 is also used as a feedback device to facilitate the user's creativity according to an example embodiment.

The collected data from state 200 leads to state 201 or state 202, or both, in which feedback data is provided to the user.

Turning to state 201, the user device 102 includes a multimedia projector and it projects visual data 204 for the user to see. The visual data 204 is, for example, projected on a surface next to the canvas 203. The user device 102 also includes an audio speaker and it outputs audio data of one or more people talking 204. The audio data, for example, is about how doors and buildings are made, or is about cultural themes relevant to the era and culture represented by the drawn door, or is about drawing/painting styles that are complimentary to the user's drawing/painting style used to draw the door.

State 202 is an alternative to state 201, or it could be another state that is shown in addition to state 201. In particular, in state 202, the user device 102 projects images directly onto the canvas 203. In addition or in alternative, the user device 102 also plays music 207. For example, the music is representative of the user's mood, or is representative of the style of the painting/drawing, or is representative of the cultural themes of the drawn door, or a combination thereof.

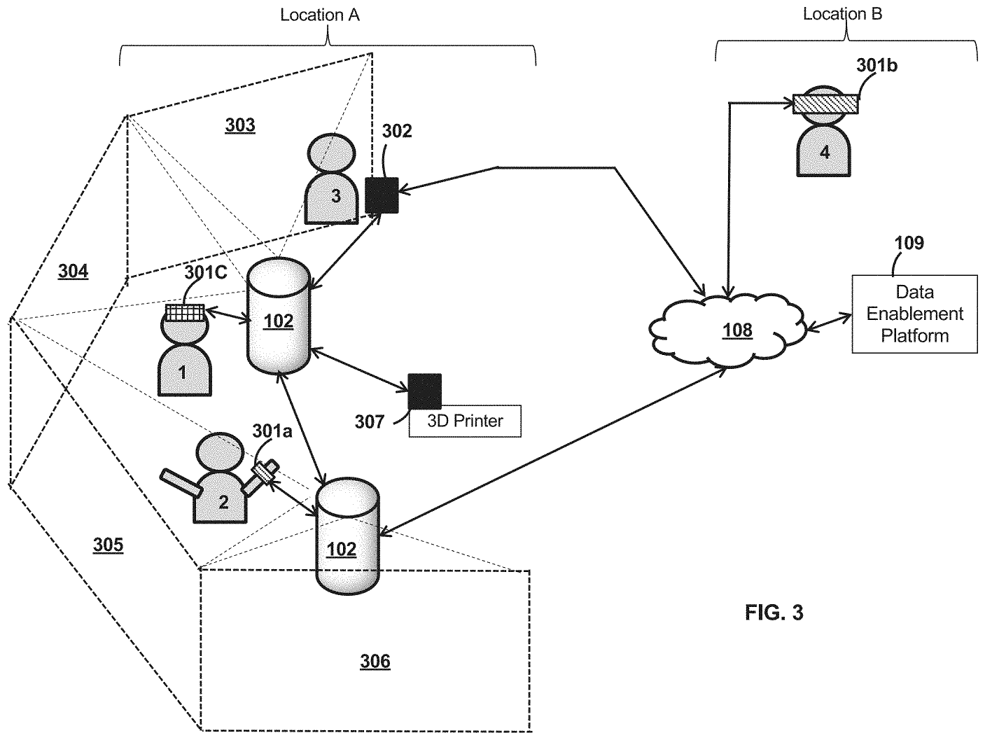

Turning to FIG. 3, an example schematic of multiple users is shown collaborating on a project, and the various devices are used to augment the creativity and innovation amongst the users.

One group of users 1, 2, 3 are at Location A, and another user 4 is at Location B. At Location A, users 1, 2 and 3 interact with user devices 102 through oral communication and visual information. In particular, the user devices 102 use microphones to detect the voices and the speech of the users 1, 2 and 3. In another example, the user devices 102 also include cameras to visually “see” the users 1, 2, and 3, such as their actions, movements and facial expressions.

Together, these users 1, 2, 3, 4, although at different locations, can interact with each other through digital voice and imagery data. The data enablement platform 109 processes their data inputs, which can include voice data, image data, physical gestures, physical movements, body posture, biometric data and brain wave data. These data inputs are then used to by the data enablement platform to provide feedback to the users.

In another example embodiment, the data inputs are processed locally on the user devices 102, and the resulting derivative data is transmitted to the data enablement platform 109. In an example aspect, the data size of the data inputs is larger than the data size of the resulting derivative data.

At Location A, the two user devices 102 are in data communication with each other and project light image areas 303, 304, 305 and 306. For example, the user devices 102 each include one or more multimedia light projectors. These projected light image areas are positioned in a continuous fashion to provide, in effect, a single large projected light image area that can surround or arc around the users. This produces an augmented reality or virtual reality room. For example, one user device 102 projects light image areas 305 and 306, and another user device 102 projects light image areas 304 and 303.

Also at Location A is a user 2 that is wearing an IoT device 301a. This embodiment of the device 301a includes a microphone, audio speakers, a processor, a communication device, and other electronic devices to track gestures and movement of the user. For example, these electronic devices include one or more of a gyroscope, an accelerometer, and a magnetometer. In an example embodiment, the device 301a is trackable using triangulation computed from radio energy signals from the two user device 102 positioned at different locations (but both within Location A). The device 301a also measures biometric information about the user 2 (e.g. heartrate, body temperature, muscle signals, etc.). In an example embodiment, this information is transmitted to the user device 102, and then to the network 108.

User 1 is equipped with a BCI device 301c that measure the user's brain signal or nervous system signals, or both. In an example embodiment, this information is transmitted to the user device 102, and then to the network 108.

User 3 is equipped with a mobile device 302. The user can interact with the mobile device 302, which in turn can interact with one or both of user devices 102, the network 108, or a combination thereof.

A 3D printer 307 is also located at Location A. It receives data from a user device 102, or directly from the network 108. The 3D printers uses the received data to generate 3D printed models or objects, which is a form of outputted feedback to facilitate creativity and innovation.

The users at Location A can talk and see the user at Location B.

Conversely, the user 4 at Location B is wearing a virtual reality or augmented reality headset 301b, and uses this to talk and see the users at Location A. This visual-type device 301b projects or displays images near the user's eyes, or onto the user's eyes. This device 301b, for example, also includes a microphone, audio speaker, processor, and communication device, amongst other electronic components. Using this device 301b, the user 4 is able to see the same images being projected onto one or more of the image areas 303, 304, 305, and 306.

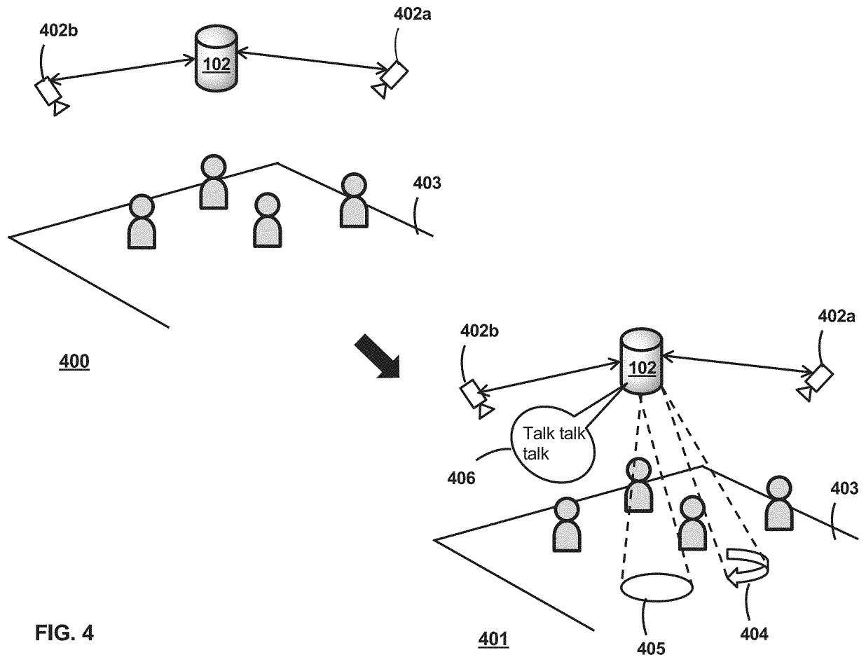

Turning to FIG. 4, another example scenario of creative collaboration amongst users is shown. An initial state 400 includes several people on a surface 403 (e.g. a ground or floor). Cameras 402a and 420b are located to above to see the people. They are in communication with a user device 102, which in turn is in communication with the data enablement platform 109. At this state 400, movement of the users is being recorded from the cameras. Voice data, for example, is also being recorded by microphones. The microphones are located on the people, located in the cameras, or located in the user device 102, or a combination thereof. The visual data from the cameras or the voice data from the microphones, or both, are used by the data enablement platform to run queries and to perform additional computations that generate feedback data.

In state 401, the user device 102 provides visual feedback 405, 404, or audio feedback 406, or both. For example, the user device 102 includes a media projector that projects images or video, or both, onto the surface 403 as visual feedback. This projected visual feedback could be video, directional indicators for suggested movement, pictures of emotions, suggested positioning, digital avatars of the people, etc. The user device 102 could also play audio feedback data 406 that could be talking, music, sounds, etc. This feedback is used to help inspire and provide creative ideas to the people as they collaborate to work together, or move together, or carry out some action together, or generate some idea together.

Below is an example embodiment of the computing processes executed by one or more user devices of a person (e.g. also called edge device(s)) and the data enablement platform to improve a person's creative process.

Step 1: A person (e.g. or animal, living organism, etc.) begins conducting experiment, thought work, painting, growing etc. based on a human idea or imagination.

Step 2: The computing system (e.g. edge device(s) of the person and the data enablement platform) simultaneously “shadows” the user capturing data and meta data creating multiple input data streams (e.g. vision, videos, sensor data, pictures, spoke language, audio, music, brain waves, nerve signals, etc.) in real time, and outputs one or more master stream files. In an example embodiment, a personal bot monitors the person and interacts with the person. In another example embodiment, the person is associated with multiple personal bots, and each personal bot is specific to a creative domain. For example, a person has a first personal bot for painting; a second personal bot for writing fiction; a third personal bot for woodworking or carpentry; and a Nth personal bot for marketing, where N is a natural number. The multiple personal bots can interact with each other, so as to share multi-domain information amongst the different personal bots. For example, the person can interact with one personal bot, or can interact with multiple personal bots (e.g. either serially or simultaneously). For example, the person's interaction with the one or more personal bots includes one or more of the following: speaking with one or more bots; gesturing to one or more bots; using brain signals, nervous system signals, or muscle signals, or a combination thereof; using biometrics; and using facial expressions.

Step 3: The computing system performs real time data science (e.g. STRIPA, machine learning, searches, etc.) on the data stream(s) to determine if the received data is new information or if information already exists in data stores.

With respect to the data science, one or more of the computing devices or the servers, or a combination thereof, execute data science. In an example aspect, Surface, Trend, Recommend, Infer, Predict and Action (STRIPA) algorithms are included in a data science algorithms library. This family of STRIPA algorithms worth together and are used to classify specific types of data science to related classes.

Step 4: The computing system presents the user with real time feedback results. This includes, for example, one or more of the following: classifying new information; informing that data already exists; presenting meta data; presenting recommendations related to master file stream(s); presenting new data that is derived from the received data; and performing real time autonomous, 3rd party searches to output relevant/contextual results related to the master file stream(s).

Step 5: Person observes (actively or passively) real time feedback as the person continues to primarily focus on idea and consequently may or may not apply the “shadow” feedback into the original thought work, experiment, painting, etc. This feedback includes, for example, one or more of the following:

a) Person may deepen his idea or imagination applied to the original thought work, experiment, painting, etc. as a result of the “shadow” feedback; computer will consequently and automatically reprocess steps 2 to 5.
b) Person may broaden his idea or imagination applied to original thought work, experiment, painting, etc. as a result of the feedback; computing system will consequently and automatically reprocess steps 2 to 5.
c) Person may pivot his idea or imagination applied to original thought work, experiment, painting, etc. as a result of the feedback; computing system will consequently and automatically reprocess steps 2 to 5.
d) Person may introduce an orthogonal idea or imagination applied to original thought work, experiment, painting, etc. as a result of the feedback; computing system will consequently and automatically reprocess steps 2 to 5.

Step 6: The computing system simultaneously (e.g. in the background unknown to user) performs deeper real time data science processing and deeper real time search processing while the person is performing steps 1 and 5. These further computations include, for example, organizing, indexing and graphing a data stream for each unique data stream. The computations can further include organizing, indexing and graphing a data stream for derivatives (e.g. original human idea and imagination, derivative human idea and imagination—deepened, broadened, pivoted ideas, orthogonal ideas, contrasting ideas) in real time. This is similar to an autonomous code store that stores and indexes primary and branch code bases.

Step 7: The computing system performs another “shadow execution process” involving searching. In particular, the computing system provides continuous searches, in real time, and further applies data science (e.g. STRIPA, machine learning) on the data store (e.g. as per step 6) in order to generate keywords, meta data, hashtags, pictures, audio, video and boolean data. This generated data are used as input parameters for performing a 3rd party search (e.g. Google, Bing, 3rd party applications and systems, social networks, ERP systems, business systems, etc.).

Step 8: The computing system performs real time searching using the data obtained at step 7.

Step 9: The computing system real time captures query results (e.g. text, audio, pictures, video, etc.) and begins performing data science on the search results. This could include modifying the resulting data.

Step 10: The computing system in real time graphs or maps the search results against data from step 6, or metadata, or both.

Step 11: The computing system presents the person with new and unique contextual data (e.g. text, pictures, audio, video, tactile data, brain signal data, nervous system data, meta data, data links etc.) and recommendations related to the original idea data stream and derivative data streams (e.g. from step 5). The outputted data could include orthogonal ideas (e.g. ideas that are not obviously related to the original idea), different contexts (e.g. contexts or environments that are different from the context or environment of the original idea), different applications (e.g. different applications from the application of the original idea), similar ideas to the original idea, ideas that are considered upstream to the original idea, ideas that are considered downstream to the original idea, and machine-learning-generated ideas.

Step 12: Person observes real time feedback, from step 11, as the person continues to primarily focus on idea and imagination applied to original thought work, experiment, painting, etc. This could include, for example:

a) Person may deepen his idea or imagination applied to the original thought work, experiment, painting, etc. as a result of the feedback; computer will consequently and automatically reprocess steps 2 to 5.
b) Person may broaden his idea or imagination applied to original thought work, experiment, painting, etc as a result of the feedback; computer will consequently and automatically reprocess steps 2 to 5.
c) Person may pivot his idea or imagination applied to original thought work, experiment, painting, etc. as a result of the feedback; computer will consequently and automatically reprocess steps 2 to 5.
d) Person may introduce an orthogonal idea or imagination applied to original thought work, experiment, painting, etc. as a result of the feedback; computer will consequently and automatically reprocess steps 2 to 5.
e) Person may opt to have active real time notification or passive notification to any of the aforementioned options. User may decide real-time updates is too disruptive to their creative thinking process.

Step 13: Person continues to focus on step 1 by creating and imagining derivatives of step 1 by using step 5 and step 12 as real time supporting feedback.

In an example embodiment, the one or more personal bots transmit and receive data with a data enablement platform (e.g. a cloud computing system) in order to execute the computations in one or more of the steps above. In another example embodiment, the one or more personal bots locally execute the computations on one or more edge devices of the user, in order to perform one or more of the steps above.

In an example embodiment, sensors are attached to a user device and the user device is connected to the data enablement platform (e.g. a cloud computing system) to do the computing. The results from the data enablement platform can then be fed back to the user device.

In another example embodiment, the entire user system is in an augmented reality room, which is connected to the data enablement platform to do the computing

In another example embodiment, an augmented reality headset provides input/output to the person, and the headset is connected to a user device, which itself is connected to the data enablement platform to do computing.

In another example embodiment, an augmented reality headset provides input/output to the person, and the headset is directly connected to the data enablement platform to do computing.

In another example embodiment, some or all of the input/output is done inside the human body or as a wearable, and these devices are connected directly to the data enablement platform or to a user device, which in turn is connected to the data enablement platform.

In another example embodiment, any of the aforementioned embodiments receive automated updates to the data science (e.g. algorithms, data parameters, etc.) from a user device or the data enablement platform.

In another example embodiment, any of the aforementioned embodiments have some or all of its input/output, computing, and data and algorithm communication residing on a IoT sensor(s), a user device(s), a device implanted on or within a human, wearable devices, laptops, and workstations.

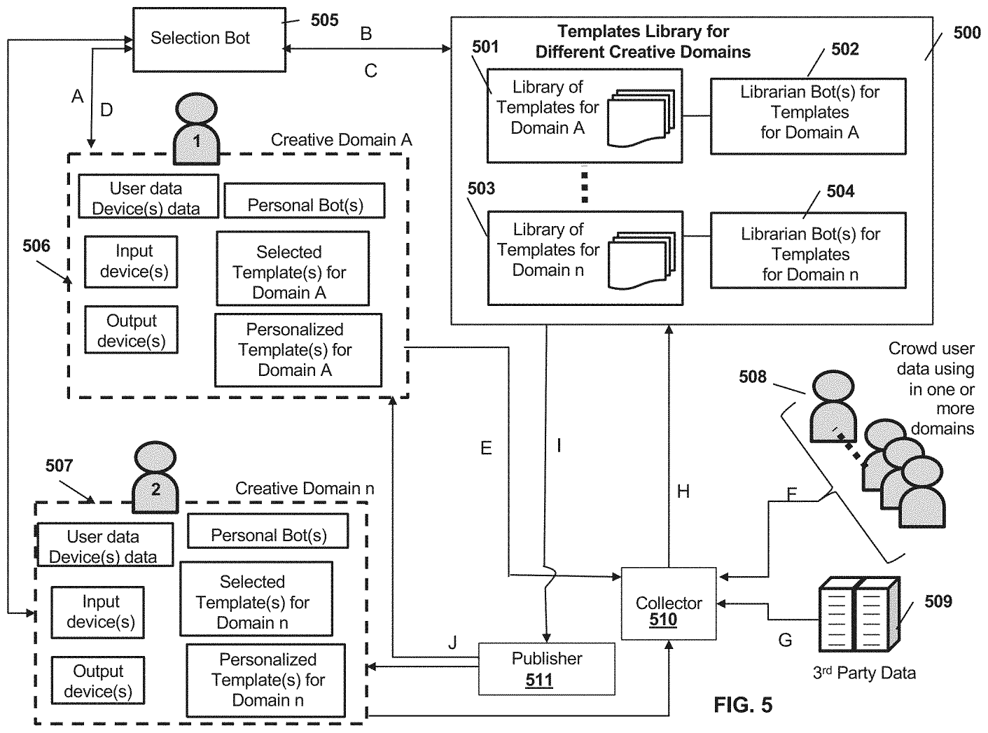

In FIG. 5, a templates library 500 is provided for different creative domains. In particular, each template includes data science, rules, data, and search algorithms that are used to augment human creativity within a particular domain. Non-limiting examples of creative domains include: visual arts, music, writing, movie and television production, theater, consumer products, cooking or culinary arts, architecture, industrial design, software design, engineering, business, science, policy, and humanities. It will be appreciated that there are other domains, and that people can create new domains, new sub-domains, and new sub-sub-domains within a given sub-domain. For example, in relation to the domain of the visual arts, sub-domains include: painting, drawing, sculpture, and digital media. The domain of music has within it many sub-domains, including different styles and genres of music and different types of instruments.

The templates are used to help new users (e.g. User 1, User 2) to more quickly adapt or obtain a bot that is applicable to their creative domain. It will be appreciated that the term “bot” is known in computing machinery and intelligence to mean a software robot or a software agent. In an example aspect, the bots described herein have artificial intelligence.

The components and overall process of FIG. 5 are described below.

In particular, a person (e.g. User 1) is interested to create within a given Creative Domain A. User 1 uses a system 506 of devices and software to create or innovate within the Creative Domain A.

At operation A, information about the user (e.g. user data) and their devices (e.g. device data) is provided to a selection bot 505. The user data includes their domain of interest (e.g. Creative Domain A) and could include other user information, such as: their thinking style, their personality, their likes and dislikes, their demographic information, their social network information, and their experiences (e.g. travel, previous projects, skills, and work experiences). Their device data includes, for example, the types of devices they are working with as they create or innovate. This information can be provided automatically using the user's personal bot, or could be provided by semi-manual input or manual input, or a combination thereof. It will be appreciated that the personal bot of User 1 is specific to User 1, and executes operations locally on the device(s) of User 1.

At operation B, the selection bot 505 accesses the templates library 500 to find templates that would be suitable for User 1. The templates library includes a library of templates specific to Domain A 501, a library of templates specific to Domain n 503, and other templates for other domains. Within the library of templates for Domain A 501, there are templates that are suitable for different devices or for different users, or both. The selection bot 505 uses the user data or the device(s) data, or both, of User 1 to run a query to find and select an appropriate template (or templates) for User 1.

At operation C, the selection bot 505 obtains the selected template(s) from the library 500, and more particularly from the library of templates for Domain A 501. At operation D, the selection bot 505 provides the one or more selected templates to User 1's system 506.

The selected template is provisioned on the system 506 for User 1. The personal bot of User 1 personalizes the selected template(s) for the user based on known information of User 1, thereby creating one or more personalized templates for User 1. Through observed user interaction with the input device(s) and output device(s) in the system 506, the personal bot over time dynamically adjusts and modifies the personalized template(s) that are specific to User 1 (e.g. their behavior, their age, their culture, their language, etc.) and Creative Domain A. In effect, different versions of the personalized template(s) are created for User 1, as the creative style, work style and thinking style of User 1 changes over time. In other words, the personal bot for User 1 develops new algorithms, new data science parameters, new data sources, new data, etc. to help User 1 create within Creative Domain A, and these developments are captured in the personalized template(s). In an example embodiment, User 1 interacts with, either in series or concurrently, multiple personal bots that are respectively associated with different creative domains.

At operation E, data from User 1's system 506 is fed back to a collector module 510. The feedback data includes, for example, raw data in relation to User 1, derivatives of the raw data, or the changes made by the personal bot to generate a more personalized version of the template, or a combination thereof. The feedback data is also tagged with the user data and device data, which could be subject to change over time.

The collector module 510, also herein referred to as a collector, also collects data from other systems 507 of other users, whether in the same creative domain or in a different creative domain. For example, at operation F, crowd data from many other users 508 is fed back to the collector 510. Crowd data includes, for example, the interaction of other users with their respective user devices. The user interaction is not limited to creative work projects, but could include user data in relation to other activities. Other types of crowd data include, for example, a user's unique voice characteristics, small talk between people, sentiment amongst people, topics discussed amongst people, jokes/sarcasm talk, current events talk, history talk, sports talk, movie talk, etc.

At operation G, the collector 510 also collects data from third-party data sources 509. Non-limiting examples of third-party data sources include databases in relation to different creative domains, databases in relation to creativity science, and databases in relation to cognitive science. These third-party data sources include publicly available data sources and privately available data sources. In an example embodiment, the collector 510 is a system that includes a collector bot itself, or a system of collector bots. For example, there is a collector bot for each creativity domain.

The collector 510 ingests and pre-processes this data for storage and for access by one or more librarian bots 502, 503.

At Operation H, a given librarian bot 502 obtains data pertinent to Creative Domain A from the collector 510 and uses this information to at least one of: modify an existing template, delete an existing template, and build a new template. In other words, the librarian bot 502 uses machine intelligence to update the one or more templates in the library 501 based on the information obtained by the collector 510. This updating process could be continuous or occur at timed intervals. The updated templates help new users, also interested in Creativity Domain A, to have more up-to-date information and processes.

In an example embodiment, each domain library has a corresponding librarian bot. For example, the library of templates for Domain n 503 is associated with one or more librarian bots 504.

The librarian bot 502 for Creativity Domain A provides the one or more updated templates to a publisher module 511 (i.e. Operation I), also herein called a publisher, and the publisher 511 transmits the one or more updated templates to the relevant user systems. In particular, the publisher 511 has computing processes that determine which particular updated templates should be transmitted to which particular user systems. In the example of FIG. 5, the publisher 510 transmits a certain updated template to the system 506 of User 1 (i.e. Operation J). The publisher 510 includes one or more publisher bots. For example, there is a publisher bot for each creativity domain.

In response, the personal bot of User 1 receives this updated template and incorporates this updated template when executing computing processes. The incorporation process includes, for example, adapting any previous personalizations that are specific to User 1. This closes the feedback loop from the collaborative network to User 1.

The selection bot, the templates library, the collector 510, and the publisher 511 are, for example, part of the data enablement platform 109.

The following is a more detailed discussion of the selection bot 505.

The selection bot 505 can use one or more types of computations or algorithms to select an appropriate template based on the provided (e.g. user data, device data, etc.). These computations are based on matching a given user system (e.g. system 506) to one or more templates. Various types of currently known and future known matching algorithms can be used to make a selection.

In an example implementation, the templates are tagged with predefined domain attributes, predefined user attributes and predefined device attributes. The selection bot 201 identifies the one or more templates that are tagged with the attributes that match the provided data.

In another example implementation, the selection bot 505 utilizes bipartite graphs to compute bipartite matching computations. For example, users represent one set of nodes and the templates represent another set of nodes in a bipartite graph. In an example embodiment, unweighted bipartite graphs are used to perform the matching. In another example, weighted bipartite graphs are used to perform the matching.

In another example implementation, the selection bot 505 utilizes fuzzy matching algorithms.

In another example implementation, the selection bot 505 uses look-alike algorithms to match a user with a template. For example, the selection bot 505 has processed the existing data to identify that many users having personal attributes and device attributes of the set [X] use the template Y. Therefore, the selection bot determines that a potential user that also has the attributes [X] should use the template Y. It will be appreciated that different attributes can be weighted differently.

In another example implementation, the selection bot 505 uses a neural network to predict (or output) which template will best match a user and their device(s). The neural network is trainable based on existing data of users and their templates.

In another example implementation, the selection bot 505 computes mutual information between a given attribute (or given attributes) of a user and a given attribute (or given attributes) of a template. The mutual information value measures the mutual dependence between two seemingly random variables. The higher the mutual information value, the higher correlated are these variables, which can be used to determine that a given user and a given template are a matching pair.

In another example implementation, the selection bot 505 computes one or more Pearson Correlation Coefficients (PCC) between a given attribute of a user and a given attribute of a template. The one or more PCCs are used by the selection bot 505 to make a selection of a template.

Other matching algorithms can be used. It will also be appreciated that multiple matching algorithms can be combined together in order for the selection bot 201 to make a selection.

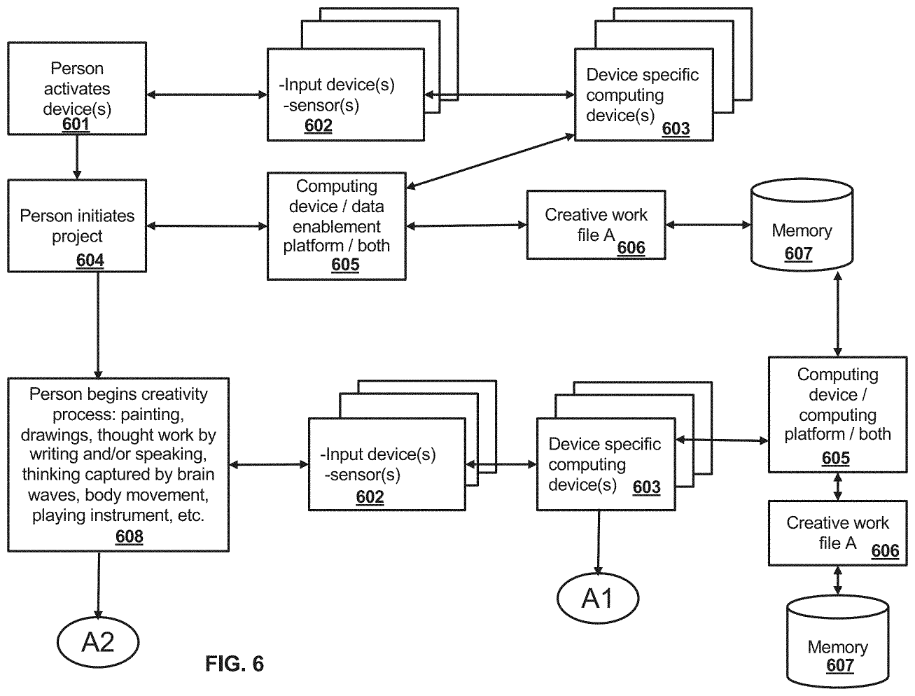

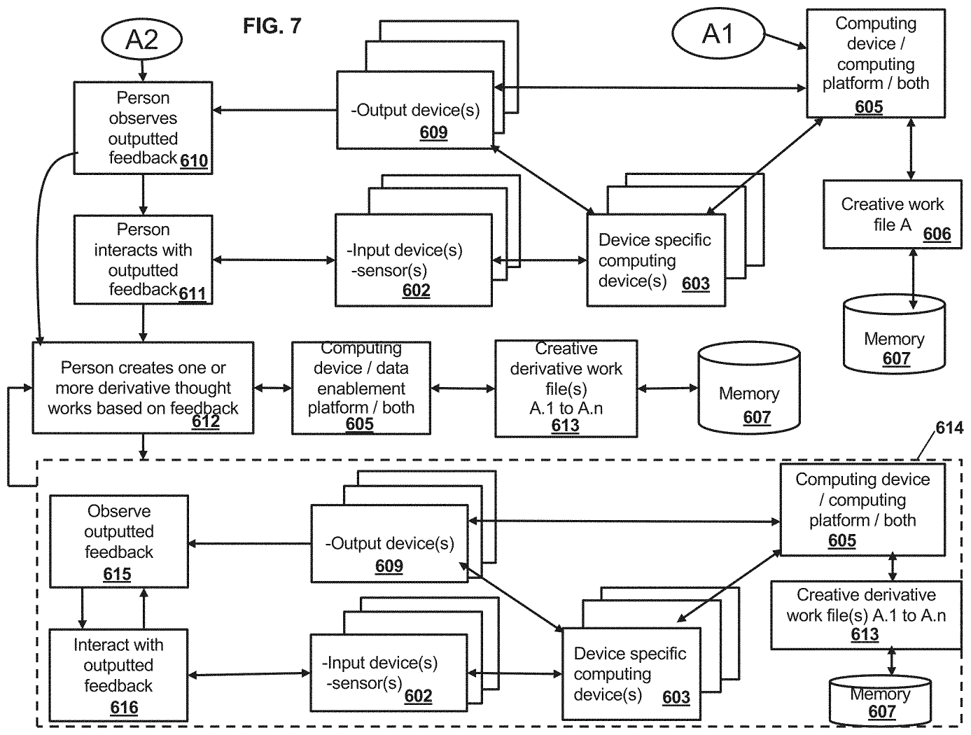

Turning to FIGS. 6 and 7, an example computational process is provided for a computing system to interact with a person to augment the person's creative process.

At block 601, a person, also called a user, activates one or more devices 602, 603, 605, 609. This includes, for example, turning on one or more system(s), application(s), cloud device(s), computer(s), IoT device(s), smart device(s), projector(s), audio video system(s), user device(s), etc. This could also include putting on wearable device(s), augmented and virtual reality devices, body IoT implants, etc.

In particular, the devices include edge devices that include the following components, or a combination of the following components: one or more input devices, one or more sensors 602; one or more device specific computing devices 603; a general purpose computing device of the user (e.g. a mobile device, a laptop, a desktop computer, a tablet, etc.); and one or more output devices 609. The general-purpose user computing device, or a data enablement platform 109 (e.g. also called a computing platform), or both, are collectively represented by numeral 605. In an example embodiment, data could optionally processed on a general-purpose computing device.

Non-limiting examples of input devices and sensors 602 include keyboards, microphones, cameras, RADAR, LiDAR, positioning sensors, chemical sensors, inertial measurement sensors, temperature sensors, pressure sensors, strain sensors, biometric sensors, gesture sensors, brain signal sensors (e.g. including bi-directional devices that can also transmit signals to affect the brain), nervous system sensors (e.g. including bi-directional devices that can also transmit signals to affect the nervous system), muscle sensors (e.g. including bi-directional devices that can also transmit signals to affect the muscle, organ sensors (e.g. including bi-directional devices that can also transmit signals to affect an organ), wearable devices (e.g. watches, head bands, clothing, glasses, contacts, etc.), mobile devices, electronic instruments, local positioning beacons (e.g. RFID beacons), and implanted devices. The types of input data depends on the type of input devices. Non-limiting examples of input data types includes: oral or speech data, text data, mouse data, document attachments, pictures, audio data, video data, brain signals, biometric data, musical data, etc.

Non-limiting examples of output devices 609 include projectors, display screens, haptic devices, electrical stimulating devices, actuators, robotics, drones, manufacturing devices (e.g. CNC machines, 3D printers), audio devices, augmented reality devices, virtual reality devices, robotics, lights, BCI devices, wearable devices, a midi device that drives an instrument synthesizer, a digital music studio software on a computing device, a 3D modelling software on a computing device (e.g. CAD, CAM), etc.

The input devices 602 provide data to the one or more device specific computing devices 603. The one or more device specific computing devices 603 exchanges data with the data enablement platform (e.g. either directly with the data enablement platform, or via a user computing device).

In another example embodiment, the one or more device specific computing devices 603 communicates data to the user computing device. Subsequently the user computing device only transmits a portion of the received data to the data enablement platform, or the user computing device transmits a processed data derivative of the received data, or both.

A creative work file A 606 is stored in memory 607, which resides on the general purpose computing device or the data enablement platform, or both.

It will be appreciated that the input devices and sensors 602 and the one or more device specific computing devices 603, in some embodiments, are integrated together in a physical housing, or, in other embodiments, are separate devices or components that are in data communication with each other.

These components 602, 603 are, for example, analog-to-digital (AD) interface sensors and devices between human and computer systems that “shadow” the person so that the person almost never interacts directly with the input systems. In some situations, depending on the mindset of the person, a person that directly interacts with the system may slow down the person's ability to deeply focus, imagine, create, and render. Therefore, it is sometimes desirable for these components 602, 603 to unobtrusively monitor the person. There can be N number of devices (e.g. IoT wearing device to capture gestures, a 3D camera to capture expressions, a set of microphones for the user to speak, etc.) enabling the system to capture the person's real time thoughts, ideas, meta data, etc. as the person is imaging, creating, and rendering. This could also include brain wave sensors that capture patterns while imagining, creating, rendering, etc. In most use cases, the majority of the person's attention is focused on the physical project or thought work (e.g. ceramics, painting, writing music on paper, positing a theory on a white board). These components 602 or 603, or both, for example, include the hardware and algorithms to locally compute data science (e.g. STRIPA, machine learning), store data, execute intelligent searches, and to transmit and receive data (e.g. via a transceiver).

At block 604, after the one or more devices are activated, the person initiates a project, which leads to the creation or provisioning of a new creative work file (e.g. creative work file A 606) that is stored in memory 607. Alternatively, an existing creative work file is pulled from the memory 607.

In an example embodiment, an input device or sensor detects a person speaking “Search for da Vinci human muscle pictures and look-a-likes”. In response, the computing system automatically activates a personal bot for da Vinci human muscle pictures and a related creative work file. The personal bot generates search queries for da Vinci human muscle pictures and for similar looking images.

At block 608, the person begins their creativity process. This could include one or multiple actions, including, for example: painting; drawing diagrams; recording thought work by writing and/or speaking; thinking of ideas that are represented by brain waves and captured by brain-signal sensors; expressing emotion and personal meaning using facial expressions; moving their body; playing an instrument, etc. While this occurs, the input devices and sensors 602 monitor these actions and activities in real time, relaying information to the other devices 603, 605 for storage and further computation.

The general-purpose computing device or the data enablement platform, or both, 605 execute real time data science (e.g. STRIPA, machine learning), storing and graphing, intelligent search, and transceiver activity in the background as person imagines, creates, and renders physical project or thought work.

Continuing with the example of da Vinci human muscle pictures, the personal bot uses the real-time input data collected about the user to dynamically and automatically modify the search queries, generating new search queries. The personal bot, via the computing system, executes these new search queries in relation to da Vinci human muscle pictures.

Turning to FIG. 7, the process continues from A2, where these computations also include, for example, data science applied to recurring patterns observed, captured, detected about the person (e.g. brain wave activity, facial expressions, gestures, writing, physical techniques, etc.). In another embodiment the intelligent searches include data science applied to autonomous search queries and data science applied to the search results. The result of process can include various types of feedback data, including, but not limited to, informational data (e.g. audio, visual, text, voice, machine data, brain-interface data, muscle-interface data, etc.) and command data (e.g. data that causes devices to execute an action). This data is outputted via the one or more output devices 609.

Therefore, at block 610, which continues at A2 from FIG. 6 to FIG. 7, the person observes the outputted feedback. The person actively or passively (e.g. this is a user definable setting) receives “shadow” information feedback that the system has autonomously performed in the background while person imagines, creates, and renders. In another example embodiment the system outputs results (e.g. pictures, movies, audio data, research writing, graphs, etc.) that are similar to the person's work.

For example, if the person chooses to receive active feedback, then the computing system provides feedback that actively engages the person. The active feedback is preferably outputted in concurrently while the person is imagining, creating, rendering, building, developing, etc. For example, the person can be actively notified by a “haptic” output on a smart watch. In another example, the system provides active feedback via a brain signal to affect the person's thinking or brain function. In another example, the system provides active feedback via a brain signal that triggers the person to think to look at a projector screen, and the system also displays relevant content on the projector screen. In another example, the computing system plays audio output as a voice bot, and that talks about another person and their work that is similar to the person's work. In another example, the computing system projects images, using a media projector, overlaid surfaces being used by the person (e.g. the person's desk, the person's canvas, the person's floor space, etc.). Other types feedback mediums can be used to actively engage the user while the person is imagining, creating, rendering, building, developing, etc.

For example, if the person chooses to receive passive feedback, then the computing system provides feedback in a manner that does not interrupt the person. In other words, while the person is imagining, creating, rendering, building, developing, etc., the computing system provides feedback (e.g. in real time, or at certain times) but does not bother or interrupt the person. At the person's leisure or convenience, the person chooses to look, listen, feel, consume, etc. the feedback provided by the computing system. For example, the computing system displays data on a display screen or via a media projector, and the person looks at the displayed data at his/her convenience. In another example, the person provides a user input to indicate to the computing system that they wish to receive the feedback, and the computing system then provides the feedback to the person. For example, the user input could be a touch gesture, a voice signal, clicking on a virtual button or a physical button, a facial expression, an action of the user looking in a certain direction (e.g. looking at a display screen/surface), or a combination thereof.

As the person consumes the feedback data (e.g. real time feels, touches, reads, sees, hears, or receives brain signals, etc. the “shadow” information), the person consequently interacts with the feedback data. In an example aspect, a physical model of an object or part of an object is formed as feedback data, and the person can then touch the physical model. The physical model can be created by using dynamically flexible surfaces that can form different shapes, by localized manufacturing techniques, by 3D printing, etc.

This interaction with the feedback data occurs in real time, for example. This real time interaction can include the person indicating that they like or dislike the feedback data; indicating that they wish to receive more similar results; indicating that wish to receive similar results specific to a particular attribute; indicating that they do not wish receive similar results; etc. The interaction with the feedback data could include the computing system detecting a feeling or a mood of the person while the person is consuming (e.g. seeing, hearing, feeling, etc.) certain feedback. The person's feeling or mood could be detected through image recognition, bio-sensors, brain signal sensors, etc. In another example embodiment, the user creates new data (e.g. as captured by input devices and sensors), updates their project/data, or deletes data and metadata related to the search results, or a combination thereof. This process of creating, updating, deleting, or a combination thereof, could be initiated by the computing system receiving user input in the form of search queries, user commands, facial expressions, gestures, brain signals, etc. In another example embodiment, the user can real time create, update, or delete emoticons associated with the data and metadata.

The person interacts with this data and metadata (e.g. liking, deleting data, updating emoticons, etc.), and the computing system uses this person's interaction to machine learn the person's interests and biases so that future data science, searches, etc. are applied to the input data, the search queries/results, and the feedback data (e.g. the “shadow” data presented to the user). In other words, the user-presented feedback recommendations reflect the person's interests and biases.

Continuing with FIG. 7, at blocks 611 and 612, the person interacts with the outputted feedback, which is detected by the input device(s) and sensor(s) 602. This interaction includes, for example, the person creating one or more derivative thought works based on the outputted feedback (block 612). In the process of the person creating a derivative thought work, the user's computing device, or the data enablement platform, or both 605 generate one or more new creative derivative work files A.1 to A.n (block 613). The suffix “0.1” to “.n” after “A” indicates that the new derivative work file is a derivative of the initial creative work file A 606. These one or more creative derivative work files A.1 to A.n are stored in memory 607.

The interaction process varies depending on the type of input devices. For example, the input devices detect a person speaking and this result will create derivative works or feedback on original work. In another example, as the user touches a physical model or a virtual model of an object (e.g. in augmented reality or virtual reality), the person modifies the shape (e.g. by carving, cutting, adding, etc.) onto the three-dimensional model. These manipulations can be detected and digitally recorded using cameras, sensors that detect the movement of a person's hands, using software interfaces (e.g. digital pointers, digital tools), LiDAR, etc. The computing system then generates a new thought work (e.g. a creative derivative work file) or updates the existing thought work (e.g. the currently existing work file) based on the detected manipulations.

The process of the person and the computing system working together to create new thoughts, ideas, concepts, etc. is repeated in block 614. In particular, based on the inputs in relation to the derivative work files 613, the computing device or data enablement platform, or both, 605, search for new feedback data or generate new feedback data, or both, and this feedback data is outputted to the person via the one or more output devices 609. The person receives, consumes, observes, etc. this outputted feedback data (block 615) and interacts with the outputted feedback data (block 616). The person's interaction is detected by the one or more input devices or sensors (or both) (block 602). This leads to the computing device, or data enablement platform, or both, 605 searching for further feedback data or generating new feedback data, or both (block 612). This could also lead to generating further new creative derivative work files. It will be appreciated that the computing process, including blocks 614 and 612, is therefore iterative.

In an example embodiment, as the person in real time works on a creative project, it is common for people to simultaneously come up with derivative projects (e.g. same music but with a different arrangement, similar painting but a different expression, similar theory but a different variable, etc.). Alternatively, the person sees a picture or video displayed by the computing system of a similar work that spurred a new idea by the person. Alternatively, the person reads an article that is presented by the computing system and that is from a researcher, or the person listens to music presented by the computing system, or both, and this feedback that is consumed by the person also spurs the person to have a new idea.

The computing system enables the person to real time create a duplicate creative file(s) and then branch off the original file to CRUD (e.g. create, read, update, delete) the derivative arrangements, expressions, variable changes, etc. The person can then orally state or key in or use an input sensor or device, for example, duplicate Creative File 1 and rename this duplicate file Creative File A.1, A.2, A.3, etc. Other naming conventions can be used. After this occurs, the person can ad hoc CRUD these derivative work file(s) and then ad hoc go back and resume work on the original Creative File A.

As the person in real time works on one or more creative project files, the computing system autonomously, in real time, and concurrently performs data science and search work related to all creative work files (e.g. original creative work file(s), derivative creative work file(s), and orthogonal creative work file(s)). There can be concurrent data science and search computational work performed on one or multiple original, derivative, and orthogonal creative work files. When the person is ready to change to a different creative work file(s), the computing system is already up to date and prepared to present active or passive feedback data (e.g. also herein called “shadow” information) at the person's convenience or leisure. The result is that the computing system works around the person's mood, creativity, brainstorming, thought work and biases as well as person's project work time and priorities.

As the person in real time works on a creative project, it is common for people to simultaneously come up with a completely orthogonal projects, ideas, thought works, artwork, etc. Alternatively, the person sees a presented picture or video of a similar work that spurred a new, unrelated idea by the person. Alternatively, the person reads a presented article from a researcher, or listened to a music riff, or both, that spurred the user to have a new idea. The person does not want to lose the orthogonal idea(s) and thought work(s) so the person can then can orally state or key in or use an input sensor or device, for example, to initiate a creative file. For example, if the person is creating or developing an idea related to Mount Everest, the file is called Creative File Mount Everest. After this occurs, the person can ad hoc CRUD this orthogonal work file(s) and then ad hoc go back and resume work on the prior creative work file(s).

As the person continues to work on the original Creative Work file A, the system autonomously, real time, and concurrently performs data science and search work related to all creative work files (the original creative work file(s), derivative creative work file(s (Creative File A.1, A.2, A.3, etc.), and orthogonal creative work file(s) (e.g. Mount Everest)). There can be concurrent data science and search computational work performed on an N number of original, derivative, and orthogonal creative work files. When the person is ready to change to the orthogonal creative work file (e.g. Mount Everest) or other creative work files (e.g. Creative File A, A.1, A.2, A.3, etc.), etc. the computing system is already up to date and prepared to present active or passive “shadow” information at the person's convenience or leisure. The result is that the computing system works around the person's mood, creativity, brainstorming, thought work and biases as well as person's project work time and priorities.

In an example aspect, by using the systems and processes described herein, a person is able to imagine, create, and render faster and thus “fail faster” compared to other creative processes. Deeper and more unique ideas, concepts, and solutions surface faster because the person spends less time researching existing or similar results. Instead, the person spends more time imagining, creating, pivoting, and rendering new ideas, thoughts, and solutions; the computing system enables the user to posit, make, create, and test thoughts and art work and real time, fail fast these posits, ideas, art work, etc.

In another example embodiment, the computing system executes data science to identify dead ends. This includes identifying concepts (e.g. tags, topics, subjects, authors, places, objects, things, brands, people, etc.) that are considered to be unhelpful to a given person and their creative project, so that the same or similar types of feedback data are not repeated or outputted to the person. In this way, the person is not lead to think of certain concepts and thought work that is not helpful in the creative process. For example, the computing system identifies unhelpful concepts or data as those feedback that have been presented before, and that have not resulted in subsequent interaction from the user (e.g. the user did not make a further search, the user did not interact with a displayed image, the user did not modify or re-listen to a sound, etc.).

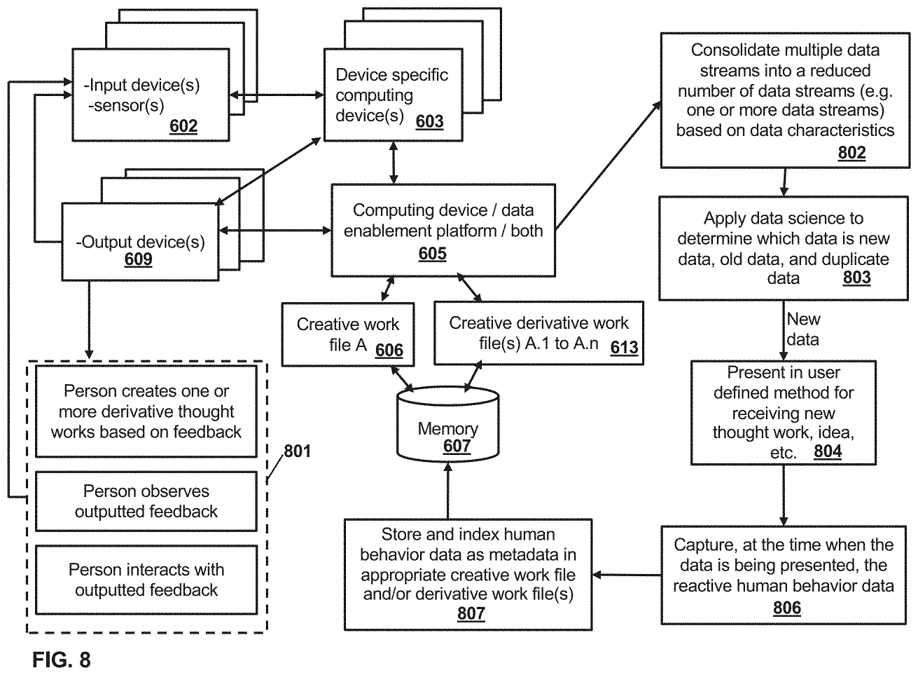

Turning to FIG. 8, similar components and data work files 606, 613 are shown, with executable instructions for processing data by the computing system. For example, data science is applied to the input data that has been obtained via the input device(s) and the sensor(s) 602. Based on the proceeded input data, feedback data is presented to the user.

In particular, the processing of one or more input data streams and the data science processing (e.g. STRIPA, machine learning) are performed on computing devices, smart devices and phones, smart IoT devices and sensors, and cloud computing platforms (e.g. the edge devices and the data enablement platform). In other words, blocks 802 to 807 are executed on one of, or a combination of, or partially on, any of the aforementioned computing devices, sensors, cloud computing platforms.

At block 801, the person at least one of: creates new thought work or derivative thought work; receives outputted feedback; and interacts with the outputted feedback. The person's reaction to the feedback data (whether intentional or not), or the user's interaction with the feedback data, or both are collected via one or multiple input devices or sensors, or a combination thereof. Multiple input devices and sensors (e.g. microphone(s), camera(s), brain activity sensor(s), wearable IoT sensor(s), etc.) produce multiple different types of data input streams.

At block 802, the computing system consolidates the multiple input data streams into a reduced number of data streams (e.g. one or more data streams) based on one or more data characteristics. Examples of data characteristics include one or more of: time, data type, predetermined patterns, and machine learned detected patterns.

In an example embodiment a single data stream is formed from the multiple input data streams based on time stamps associated with the input data. This synchronizes the multiple input data streams with the common denominator of time.

For example, there are devices DA, DB, and DC that each provide their own data stream, with each data component tagged with a time stamp, indicated by a time suffix “0.1”, “0.2”, “0.3”, etc, to form DA={DA.1, DA.2, DA.3 . . . etc.); DB={DB.1, DB.2, DB.3, . . . etc.}; and DC={DC.1, DC.2, DC.3, . . . etc.}. A unified master data stream U has time stamped components too where U={U.1, U.2, U.3, . . . etc.}, and where U.1=(DA.1, DB.1, DC.1); U.2=(DA.2, DB.2, DC.2); U.3=(DA.3, DB.3, DC.3); and so forth. In other words, time is the common denominator.

In another example embodiment, at block 802, the computing system captures and transforms all input signals into a master file containing only new and unique signals as a common denominator. New and unique signals would be processed using data science (e.g. STRIPA and machine learning).

In another example embodiment, at block 802, the computing system captures and transforms all input signals into a master file containing only common pattern signals as a common denominator. New and unique signals would be processed using data science (e.g. STRIPA and machine learning).

In another example embodiment, at block 802, the computing system captures and transforms the input signals into a master track, also called a master file, which incorporates (e.g. human and or data science driven) CRUD changes to each or all the input signals prior to the final master file.

In an example embodiment, this master file is processed and stored using immutability computations. In other words, the master file is immutable. For example, a master file is time stamped and is encrypted. Authorized changes, also called “deltas”, such as those changes made by the person or by devices or bots authorized by the person, are time stamped and encrypted. These collection of changes are stored in a distributed manner across many edge devices. In an example embodiment, the master file and the changes made to the master file are stored on a block chain. In another example, the master file and the changes made to the master file are partially stored on user-authorized devices and partially stored on other edge devices and cloud computing systems. In another example, master file and the changes made to the master file are stored on immutable ledgers (e.g. distributed ledgers, partially distributed ledgers, or locally stored ledgers), blockchains, or ledgerless blockchains, or a combination thereof. It is appreciated that currently known and future known immutability technologies are applicable to the principles described herein.

In another example embodiment, at block 802, the computing system performs one or more of the operations described herein with respect to block 802 and further keeps all the individual data streams.

In another example embodiment, at block 802, the computing system executes one or more of the aforementioned embodiments and incorporates data, metadata, and data science applied signal CRUD changes from external cloud systems, data stores, applications, and people prior to creating the master file.

For example, if the data is new, at block 803, the computing system could perform an autonomous search query and return text, pictures, movies, audio clips, etc. that is similar to the new data.

At block 803, the computing system applies data science to determine which data is new data, old data, and duplicate data.

At block 804, for the data that has been determined to be new data, then the computing system outputs feedback data to the person using the person's preferred method of communication (e.g. passive or active feedback).

Conversely, in an example aspect, for the data that has been determined to be old or duplicative data, then the computing system does not show this data. Alternatively, the old or duplicative is data is processed and outputted in a different form (e.g. different visual format, different audio format, different tactile format, switching from visual format to audio format or vice versa, switching from visual format to tactile format or vice versa, switching between output formats in general, etc.).

In another example embodiment, at block 803, the computing system additionally incorporates data, metadata, and data science applied to new or duplicative results from external cloud systems, data stores, applications, and people prior to presenting the user data. For example, if the data is new, the computing systems perform an autonomous Internet search engine query and returns text, pictures, movies, audio clips, etc. that is based on the new data. For example, the search for data could be similar to, or purposely different, from the new data.

At block 806, the computing system captures, at the time when the data is being presented, the reactive human behavior data. In other words, the person's reaction data is recorded in real time and includes, for example, one or more of: facial features, speech/voice data, gestures, brain signals, heart rate, EEG data, ECG data, IoT sensor data, emotional state, cognitive state, physiological state, environmental data, selection of a like button or a dislike button, text data, etc.

At block 807, the computing systems stores and indexes this human behavior data as metadata in the one or more appropriate work files 606, or derivative work files 613, or both.

The computing systems applies data science against this data to present to the person feedback data (e.g. including recommendations and conditions) which led to successful master file imaginations, creations, and renderings.

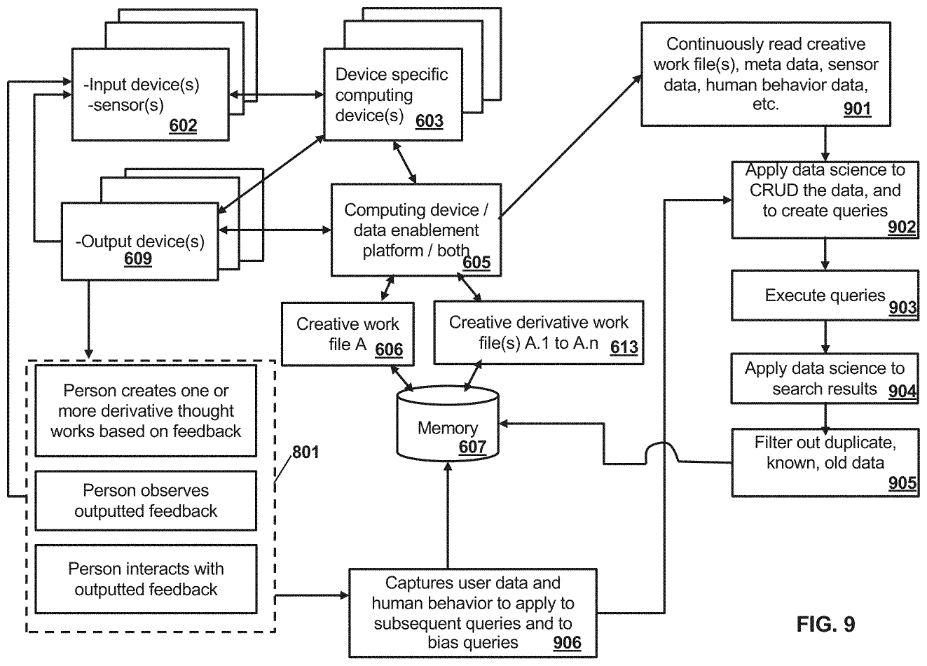

Turning to FIG. 9, example computer or processor executable instructions are provided for conducting queries based on the data obtained from the person when interacting the computing system.

In an example aspect, the search query is performed and processed in real time and data science (e.g. STRIPA, machine learning) is applied to search query and search results. The search results impact what the computing system presents to the person during active or passive notification. The operations in blocks 901 to 906 can reside on one or more, or on all of, or partially on, any of the aforementioned computing devices, sensors, smart devices, laptops, and cloud computing platforms.

At block 901, the computing system continuously reads creative work file(s), metadata, sensor data, human behavior data, IoT data, system logs, brain signals, audio data, image data, videos, text data, etc. This process also includes, for example, executing real time and non-stop searching against each of the creative file projects that have been previously stored and indexed in a data store.

At block 902, the computing system applies data science and CRUD (e.g. create, read, update, delete) to the data, in order to generate search queries. This process, for example, is executed in real time. At block 903, the search queries are executed. For example, the search queries are executed on public Internet search engines (e.g. Google, Bing, etc.) or on private databases, or both.

In an example aspect of block 902, the data and meta data residing in the data store (e.g. gestures, oral conversations, paintings drawn, white board drawings, instrument riffs, facial expressions, brain signals, facial expressions, voice data, text, images, etc.) are translated into query terms and booleans using keywords, hashtags and meta data. The formation of the query terms and Booleans are also generated, for example, using STRIPA and machine learning. For example, a person's studio camera takes a picture of a person's painting, and performs a search for pictures or images that look similar, or have similar elements. In other words, the computing system uses image processing to identify various characteristics, including: objects in the person's painting; the painting style; the overall composition of objects, etc. The computing system then executes a search using one or a combination of these identified characteristics. For example, the person's painting is of a house beside a tree that is painted in a painterly style using oil paints. In an example embodiment, the computing system searches for images that are also painted in a painterly styles using oil paints, and that include a house and a tree. In another example embodiment, the computing system searches for images of houses and trees, even though the images are photos, sketches, 3D computer graphic renderings, or different painting styles, or a combination thereof. In another example, the computing system searches for images of paintings that are also painted in a painterly style, and that do not necessarily include houses or trees.

N number of autonomous searches can occur simultaneously against N number of creative projects. In one example embodiment, there is one search for each creative project. In an alternative embodiment, there could be multiple searches performed for each creative project. For example, a given creative project has a first search query for a social network, a second search query for a blog and forum, and a third search query for a search engine.

The search queries provides search results. At block 904, data science is applied to the search results. At block 905, the computing system filters out duplicate data, known data, and old data.

Data can also be filtered based on constraints, such as date thresholds, cost thresholds, topic thresholds, data size thresholds, avoided key words, location constraints, etc.

In example aspects of blocks 904 and 905, the search results from the search engines are cached and stored. Data science is applied to the search results to surface, correlate, and recommend data and metadata that is contextually appropriate for the person's creative project. This contextually correct search result data and meta data is stored (e.g. pictures, links, text, audio, video, biometric data, etc.) and correlated with the person's specific creative file. The computing system then presents to the person while the person is working on the specific creative file. This search process continuously and iteratively runs and updates the data store and creative file when new or different information is discovered in subsequent searches. Duplicate search results are discarded.

In parallel to blocks 901 to 905, the person is observing and interacting with the outputted feedback, as per block 801. Further to block 801, at block 906, the computing system captures user data and human behavior data to apply to subsequent queries and to bias queries. This capturing process includes, for example, applying machine learning to extract human behavior from the obtained user data. This user data and human behavior data affects the operations in block 902. In another aspect, the user data and the human behavior data is stored in memory 607 in the appropriate work files.

In an example aspect of block 906, the user can interact with these search results including liking, disliking, requesting more similar data, requesting less of the same type of search results, CRUDing query words, hashtags, pictures, musical riffs, etc. Machine learning captures these users inputs, stores these new learned and revised user preferences, and applies these learnings into the search query (e.g. keywords, boolean, hashtags, pictures, etc.) prior to performing the next search(es).

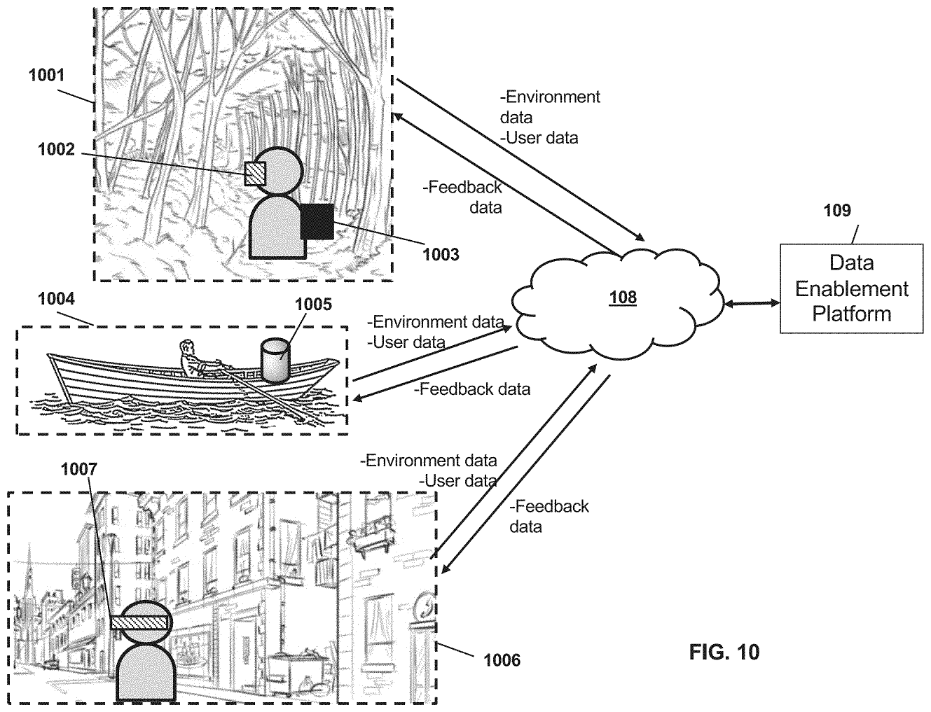

Turning to FIG. 10, example embodiments of environment data are used to generate or bias search queries. It is recognized that people are sometimes inspired by their environment or surroundings to be creative. For example, people travel to different cities, experience different cultures, or spend time in nature (e.g. forests, mountains, icebergs, lakes, waves, waterfalls, rivers, etc.) to clear their mind and to see if aspects of their environment prompt them to have creative ideas, solve problems, developing something new, etc.

In an example environment 1001, a person is in a forest. The person is equipped with a wearable device 1002 (e.g. an augmented reality visual device, or an audio device, or a brain computing interface, or a combination thereof) and carries a mobile device 1003 (e.g. a smartphone). The mobile device 1003 and the wearable device 1002 are in data communication with each other. These devices gather user data and environment data. For example, the environment data includes image data (e.g. pictures or video, or both obtained by one or more cameras) of a winding path in the forest, colorful trees in autumn, the other plant life, and animal life. The environment data also includes, for example, audio data (e.g. birds chirping, wind rustling leaves, etc. obtained by one or more microphones). The environment data also includes, for example, positioning coordinates (e.g. via GPS). The user data and the environment data are sent, via the data network 108, to the data enablement platform 109 to run search queries. If the person's project is in relationship to a given Topic A, then the data enablement platform 109, for example, searches for the given Topic A that is also related to one or more of: winding paths, forests, autumn, autumn colors, birds, chirping sounds, wind, etc. In this way, the environment data biases the search queries. As a result, the feedback data that is presented to the person is relevant to the person's environment and their Topic A. In this way, the feedback data helps to inspire the person's creativity utilizing the person's immediate environment.

In an example environment 1004, a person is on a boat and has with him a stand-alone user device 1005. This device 1005 includes one or more cameras, one or more microphones, one or more display devices, one or more processors, memory, and one or more communication devices. In an example embodiment, the one or more display devices includes a display screen or a media projector, or both. The device 1005 can include other types of sensors, including, but not limited to orientation and position sensors (e.g. inertial measurement unit sensors). The device 1005 senses the environment data using the camera(s) and the microphone(s), such as the boat, the water, upward and downward rocking of the boat, sounds of the waves, sounds of the wind, etc. Other sensors could be used as well. This environment data and the user data is transmitted to the data enablement platform 105 in order to run search queries for content in relation to a given Topic A of the user's creative interest. The search queries, which are constructed on either the user device 1005 or the data enablement platform 109, or both, include content for the given Topic A and environment data. Therefore, feedback data includes content relevant to the given Topic A and includes aspects related to one or more of: a boat, the water, upward and downward rocking of the boat, sounds of the waves, sounds of the wind, etc. In this way, the feedback data helps to inspire the person's creativity utilizing the person's immediate environment.

In an example environment 1006, a person is walking in a given city and is equipped with a wearable device 1007 (e.g. an augmented reality visual device, or an audio device, or a brain computing interface, or biometric device, or a combination thereof). In an example aspect, this device 1007 includes, amongst other components and sensors, one or more cameras and one or more microphones. The device 1007 senses the environment data, such as the buildings, the roads, the people on the streets, the cars on the street, the street signs, the business signs, the sounds of people talking, the sounds of the traffic, the sounds of construction, etc. The environment data could also include the location (e.g. GPS coordinates, the address at which the person is located, etc.). This environment data and the user data is transmitted to the data enablement platform 105 in order to run search queries for content in relation to a given Topic A of the user's creative interest. The search queries, which are constructed on either the user device 1007 or the data enablement platform 109, or both, include content for the given Topic A and environment data. Therefore, feedback data includes content relevant to the given Topic A and includes aspects related to one or more of: the buildings, the roads, the people on the streets, the cars on the street, the street signs, the business signs, the sounds of people talking, the sounds of the traffic, the sounds of construction, etc. In another example, the computing system is able to identify a culture associated with the detected environment (e.g. French culture, Danish culture, New York culture, American-West Coast culture, Japanese culture, Chinese culture, etc.), and the computing system generates search queries relevant to the given Topic A and the identified culture. In other words, content that is specific to the given Topic A and to the cultural concepts and symbols of the identified culture, is outputted to the person as feedback. In this way, the feedback data helps to inspire the person's creativity utilizing the person's immediate environment.

In an example embodiment, the computing system (e.g. which includes the devices 1002, 1003, 1005, 1007 or the data enablement platform 109, or both) detects that the given person is creative and positively responds to their given environment. In other words, based on the person's interaction with the feedback data and the person's generation of ideas, the computing system determines that the given person is more likely to have creative ideas in certain given environments (e.g. in nature, on a boat, in city scene, in a café, etc.). These environments and their attributes are stored in memory. In future or subsequent creative co-computing sessions, when the person is not located within those certain creativity-inducing environments, the computing system generates images (e.g. video, images, multimedia projections, augmented reality, visual reality, etc.) or sounds (or both) of those creativity-inducting environments. For example, if the computing system determines that a given person's creativity is correlated with a beach environment located in California, then the computing system outputs videos or sounds (or both) of beaches located in California. The video, for example, was recorded by the given person when they were last walking at the beach in California. In another example embodiment, the computing system generates or obtains images or sounds, or both, that have attributes of the environments. For example, the feedback data includes visual attributes such as beach-colored images and text (e.g. beige, sandy-textured images, blue, white, etc.), beach-themed images (e.g. images that include waves, sand castles, beach chairs, surf boards, beach umbrellas, etc.), beach-themed music, etc. In this way, images or sounds of environments that are highly correlated with a given person's creativity, or attributes of such environments, are used by the computing system to increase the person's creativity even when they are not physically located in such environments.

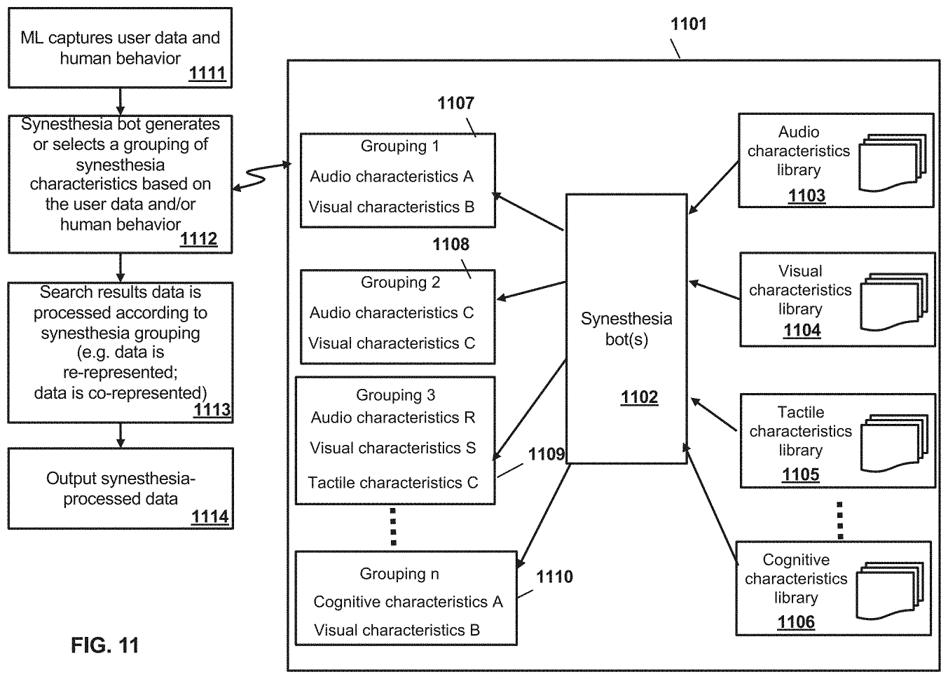

Turning to FIG. 11, the computing system (e.g. the user edge devices, the cloud computing platform, the intermediary devices, etc.) includes one or more synesthesia engines 1101 that combines data that is detectable by different senses. The combined data is, for example, outputted to a person using one or more output devices. For example, one output device outputs visual portions of the combined data and another output device outputs audio portions of the combined data.

Synesthesia in people is typically understood to be a perceptual phenomenon in which stimulation of one sensory or cognitive pathway leads to automatic, involuntary experiences in a second sensory or cognitive pathway. For example, a person can inherehtly “see” a sound; a person can inherently “taste” a color; and a person can inherently “hear” a texture. For example, in color-graphemic synesthesia, a person “sees” letters or numbers as inherently colored, although the letters or numbers are, for example, black. In spatial-sequence synesthesia, or number form synesthesia, numbers, when a person reads or hears months of the year, or days of the week elicit precise locations in space. For example, when a person reads or hears 1980 and 1990, the person perceives 1980 to be “farther away” than 1990. Synesthetic associations can occur in any combination and any number of senses or cognitive pathways.

It is herein recognized that the principles of synesthesia can be helpful to a person's creativity, imagining, development of solutions, thought work, etc. The synesthesia engine 1101 generates synesthetic associations 1107, 1108, 1109, 1110 from different sensory libraries 1103, 1104, 1105, 1106 and these synesthetic associations are used by the computing system to generate or modify the feedback data outputted to the user. In this way, the feedback data engages the person using multiple cognitive pathways or senses in a co-ordinated manner, which helps the person form new thought patterns, new ideas, new solutions, etc.

The synesthesia engine 1101 includes, for example, an audio characteristics library 1103, a visual characteristics library 1104, a tactile characteristics library 1105, and a cognitive characteristics library 1106. There are other libraries, for example, such as for smell and taste. It will be appreciated that output devices that cause a person to directly or indirectly perceive a smell or a taste, or both, are applicable to the computing system described herein.

The audio characteristics library 1103 includes, for example, multiple audio characteristics. Examples include different musical instrument sounds, different tones, different voices (e.g. of people that a given person knows like a spouse, parent or friend; of famous people; of generic personality voices, etc.), different machine noises, different animal sounds, different sounds from nature (e.g. waves, wind, rain, etc.), different musical scores and riffs, different rhythms, different tempos, etc.

The visual characteristics library 1104 includes different visual characteristics. This could include, for example, different lines, different colors, different shapes, different sizes, text, different images of things, different images of people, different images of places, different opacity and translucency settings, different positioning settings, different rotation settings, different image filters, etc.

The tactile characteristics library 1105 includes different tactile characteristics. This could include, for example, different tactile sensations and textures (e.g. buzzing, pushing, pulling, vibrating, electrocuting, shocking, rolling, heating, cooling, bumpy surface, smooth surface, fuzzy surface, wet, dry, sandy, etc.), the magnitude or amplitude of these tactile sensations and textures, the duration of these tactile sensations and textures, and the location of where these tactile sensations and textures are felt on a person's body.

The cognitive characteristics library 1106 include cognitive concepts such as distance, time, countries, activities, bad, good, old, new, emotions, culture, languages, people, ages, peace, war, bullish, bearish, conservative, liberal, master, servant, leader, follower, taking, giving, trading, sharing, natural, human-made, important, unimportant, health conditions, familiarity and unfamiliarity, safety and danger, etc.

It will be appreciated that the characteristics in the libraries can be pre-populated for users, can be user defined, or both. For example, the libraries are pre-populated with an initial data set, and the user adds more characteristics to the libraries as it suits their purposes.

One more synesthesia bots 1102 select two or more characteristics from a library or from multiple libraries. The two or more characteristics are combined together to form a synesthetic grouping. For example, one grouping 1107 includes a given audio characteristic A associated with a given visual characteristic B. Another example grouping 1108 includes a given audio characteristic C associated with a given visual characteristic C. Another example grouping 1109 includes the association of a given audio characteristic R, a given visual characteristic S, and a given tactile characteristic C. Another example grouping 1110 includes a given cognitive characteristic A associated with a given visual characteristic B.

An example includes representing musical notes (e.g. an audio characteristic) with a continuous graph line that moves to different height positions (e.g. a visual characteristic). Another example includes representing voices of people (e.g. an audio characteristic) with different shapes (e.g. a visual characteristic). Another example includes representing different images of things (e.g. a visual characteristic) with different musical instruments (e.g. an audio characteristic) and with different buzzing pulse patterns (e.g. a tactile characteristic). Another example includes representing different emotions (e.g. a cognitive characteristic) with different images of places (e.g. a visual characteristic).

It will be appreciated that there are many other combinations and permutations for the synesthetic associations made by the synesthetic engine 1101.

Continuing with FIG. 11, in an example implementation of utilizing the synesthetic engine, at block 1111, the computing system captures the person's user data and human behavior, which includes for example, applying machine learning to the obtained input data or sensor data, or both.

At block 1112, the synesthesia bot generates a new grouping of synesthesia characteristics or selects an existing grouping of synesthesia characteristics based on the user data, or the human behavior, or both. For example, if the user data reveals that the person has an affinity to music, then the synesthesia bot generates or selects a grouping that represents words as musical data. For example, if the user data reveals that the person has an affinity to cars, then the synesthesia bot generates or selects a grouping that represents different countries (e.g. whether by audio or visual), as different images of cars. For example, if the human behavior reveals that the person is getting sleepy from looking at videos of people talking, then the synesthesia bot generates or selects a first grouping of representing people with a shape, and generates or selects a second grouping of representing certain words spoken by the people with different loud noises. In other words, two or more groupings can be applied simultaneously to the video, to help wake-up and engage the sleep person.

At block 1113, the search results data, which is pre-processed feedback data, is processed according to the one or more selected or generated synesthetic groupings. Data of one type can be replaced and altogether re-represented with one or more data types according to the grouping. In another example, data of one type is represented alongside or overlaid with one or more other data types according to the grouping. It will be appreciated that re-representation or co-representation is based on mappings of different data types as determined in the groupings, which is held consistent for some period of time.

For example, in the scenario of a video of people talking, there are three people talking in a panel about city planning. Every time a first person talks, a shape of a triangle outline is overlaid around the first person's head in the video; every time a second person talks, a shape of a star outline is overlaid the second person's head in the video; and every the third person talks, a shape of circle outline is overlaid the third person's head in the video. Simultaneously, every time any person says the word “sustainable”, a sound of chimes is automatically played; every time any person says the word “traffic”, a sound of car horns is automatically played; and every time any person says the word “school”, a sound of children playing is automatically played.

In another example scenario, in a video of people, their emotions are represented with colors. The computing system recolors the faces of angry people with red; recolors the faces of happy people with yellow; recolors the faces of timid people with blue; recolors the people of passionate people with orange; and recolors the people of neutral people with grey.

In another example scenario, the search results are of images of countries. The grouping dictates that the countries are associated with music. Therefore, the images of different countries are altogether re-represented with music. Therefore, instead of showing an image of China, the computing system plays Chinese music; instead of showing an image of Columbia, the computing system plays Columbian music; instead of showing an image of France, the computing system plays French music; and so forth.

At block 1114, the computing system outputs the synesthesia-processed data as feedback to the user.

This re-representation or co-representation of data, or both, helps a person to consider data from another perspective, which helps with their creative process.

In an example aspect, the personal bots transmit data to the synesthesia bots. The synesthesia bots use data science (e.g. STRIPA, machine learning) to identify which synesthetic groupings are effective or popular to certain people or to certain creative domains, or to both. For example, trends and patterns are detected by at least collecting data from many people as to how they react or interact with various synesthetic groupings, and then by applying data processing to the collected data. This helps to form a ranking of preferred or effective synesthetic groupings in relation to characteristics of a user, or to certain creative domains, or to both.

In an example aspect, the collected data of synesthetic groupings (e.g. in relation to user characteristics or certain creative domains, or both) is used to train a neural network. The trained neural network is then used to predict synesthetic groupings by user characteristics or by creative domain, or by both.

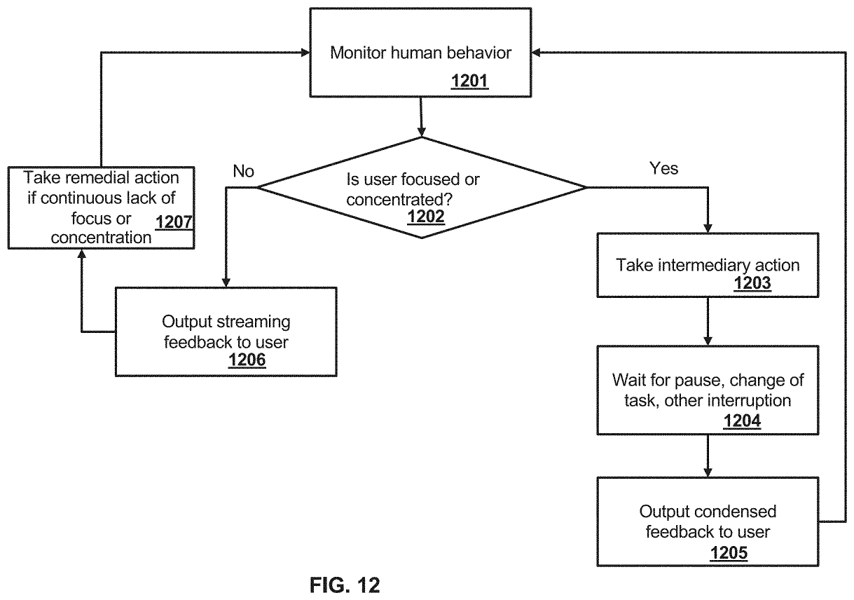

Turning to FIG. 12, example computer or processor executable instructions are provided for providing feedback data to a person in response to their state of focus or concentration. At block 1201, the computing system monitors the person's human behavior, such as via the data collected from the input devices or sensors, or both.

At block 1202, the computing system determines whether or not the person is focused or concentrated based on the human behavior. For example, a person that is focused or concentrated when painting has their eyes open and constantly looking at the canvas, and their painting actions (e.g. movement of the brush between paints and canvas) is ongoing. A person that is focused or concentrated on building an object (e.g. using augmented reality, virtual reality, or physically with tools and physical materials, or a combination thereof) has their eyes focused and looking at the object, and their actions (e.g. use of virtual tools, use of physical tools, manipulation of the object, etc.) are ongoing. In another example, a person that is focused or concentrated on composing a speech or prose, would be looking at their screen while typing in an ongoing manner (e.g. detecting a certain number of words typed per minute) or constantly speaking to a voice-bot or a dictation-bot (e.g. detecting a certain number of words spoken per minute).

Conversely, the computing system determines that a person is not focused or is not concentrating by their facial expressions, by their actions, by their gestures, etc. For example, the computing system detects that a person is not looking at the canvas, object, screen, etc. This occurs when the person stares off into another direction (e.g. to talk with someone else, to rest, to look at something else, etc.) or closes their eyes. In another example, the computing system detects that the person has altogether stopped their actions (e.g. painting, typing, building, speaking, etc.). In another example, the computing system detects that the person has moved away from their work station.

If the computing system determines that the person is focused or concentrated, then the computing system takes intermediary action with respect to the feedback data (block 1203). In an example embodiment, this intermediary action includes not outputting feedback data. By withholding the output of the feedback data, or not providing any output, the computing system does not disturb the person and helps the person to maintain their concentration or focus.

In another example embodiment, this intermediary action includes the computing system outputting white noise in the background. Examples of white noise include waves, forest sounds, the sound of a running shower, the sound of machines, the sounds of cars, etc.

In another example embodiment, this intermediary action includes showing serene images, such as pictures or videos (or both) of a campfire, walking paths in a forest, a beach, a café, a person's backyard, etc.

The white noise and the serene images help a person to maintain their concentration or focus.

In another example embodiment, this intermediary action includes outputting the feedback data, but in a diminished or muted manner, so as to reduce the disturbance to the person. For example, images (e.g. pictures or video) are shown in smaller size, with muted colors, at a location peripheral to the person's field of view, with a translucent setting, etc. For example, sounds are played in lower volume.

It will be appreciated that various approaches can be implemented at block 1203.

At block 1204, the computing system waits for the detection of a pause, change of task, or other interruption from or to the person. In other words, the computing system waits for a moment when the person is detected to be no longer focused or concentrated, whether this moment is brief (e.g. a few seconds) or long (e.g. minutes or hours).

For example, while a person is focused on painting or writing prose, the person briefly looks away to rest their eyes or to consider something else. In another example, a person stands up from their workstation to rest, go the bathroom, stretch, etc. Other types of breaks, pauses, interruptions, etc. can be detected using cameras, microphones, wearable devices, etc. In another example, the computing system detects from brain signals that the person is no longer concentrating.

At block 1205, in response to detecting a pause, a change, or an interruption, the computing system then outputs a condensed feedback to the person. The condensed feedback, for example, includes the most relevant feedback data. Less relevant feedback data is not outputted. In another example, the condensed feedback is a summary or abstraction, or both, of the feedback data that has been gathered. In another example, the condensed feedback is timed to be over a short duration, as the person may want to return to their concentration or focus state.

From block 1205, the process continues back to block 1201, where the computing system continues to monitor user data and human behavior. For example, if the person starts to interact with the condensed feedback data, then the computing system outputs streaming feedback data to the person (block 1206). Or if the person is no longer focused or concentrated, then the computing system outputs streaming feedback data to the user (block 1206).

In another scenario, if the person is just starting their creative work, the computing system detects that they are not focused or concentrated, and the computing system in turn outputs streaming feedback data to the person (block 1206).

At block 1207, if the computing system detects that the person is continuously not engaged with the creative work, development, thinking, etc., which means a lack of concentration or focus for an extended period of time (e.g. some threshold time of x minutes), then the computing system takes remedial action.

The remedial action at block 1207 includes, for example, the computing system showing pictures, videos, sounds, music, etc. that prompt the person concentrate or focus, even it is on something else. For example, the pictures or videos are of surfing, skiing, a campfire, a river, etc., or pictures or videos of past vacation or trips from the person, or combinations thereof. The computing system plays music that encourages concentration. For example, this could be music at a certain tempo and that is upbeat, such as music used by runners.

In another example, the remedial action at block 1207 includes the computing system prompting the person to represent a concept that is relevant to the person's creative work in another form. For example, if the person's creative work relates to creating or designing a new sofa couch, the computing system identifies the following related concepts: sitting, sleeping, and softness. In an example, the computing system prompts the person to sing a song about sitting. In another example, the computing system prompts the person to write a story about sleeping. In another example, the computing system prompts the person to dance the concept of “softness”. Other example approaches of representing a concept, object, person, topic, etc. in a different manner could be used. This prompts the person to think creatively and across different domains.

In an example aspect of the process shown in FIG. 12, the computing system continues to monitor the person's input with the user devices and the sensors, including the person's reactions to the outputted feedback. As a result of this monitoring, the computing system continues to generate search queries and to return search results, which are potentially used for feedback. The monitoring and the searching are ongoing and concurrent with the operations described with respect to FIG. 12.

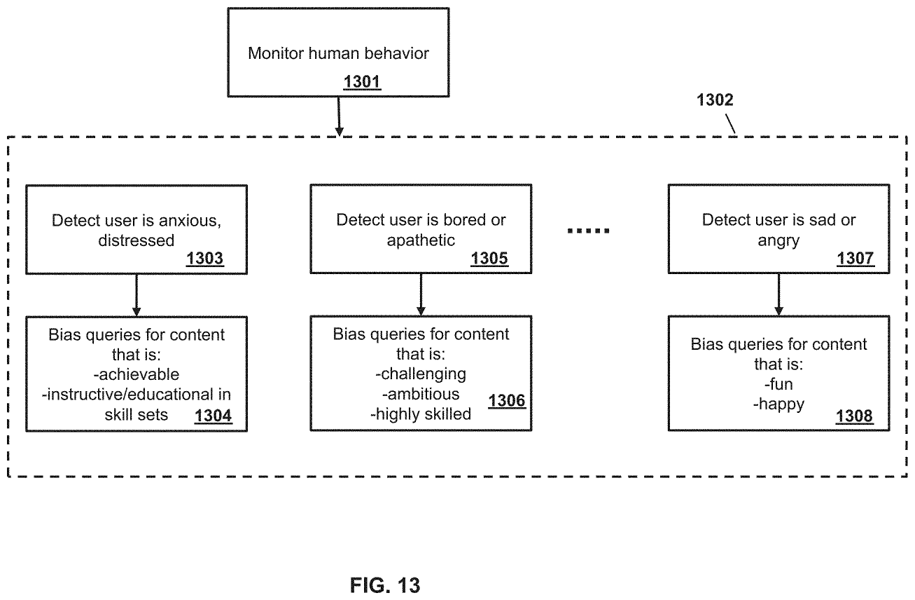

Turning to FIG. 13, example computer or processor executable instructions are provided for biasing or modifying search queries. At block 1301, the computing system monitors the person's human behavior. As noted earlier, this could be detected by monitoring various attributes about the person in real time and applying machine learning to classify the person's behavior.

At block 1302, the detected human behavior of the person is used to affect the search queries.

For example, if the person is detected to be anxious or distressed (block 1303), the computing system biases or modifies the search queries to reveal content that is one or more of: achievable, instructive, educational, etc (block 1304). For example, a person's creative project is to create or design a new boat. The computing system detects that the person is anxious or distressed. In response, the computing system searches for content that is achievable, such as images of model boats, simplistic boats, and boat kits. In another example, the computing system searches for content that is instructive or educational, such as videos that show how to assemble a boat from a kit of parts, how to operate a sailboat, how boats are made, etc. This helps the person to feel more confident and engaged about their own project to create or design a new boat.

In another example, the computing system detects that the person is apathetic or bored (block 1305). In response, the computing system biases or modifies the search queries to reveal content that is one or more of: challenging; ambitious; and highly skilled (block 1306). For example, a person's creative project is to create or design a new boat and the computing system detects that the person is bored or apathetic. In response, the computing system searches for content that is one of challenging, ambitious or highly skilled. Examples of such content include futuristic boats, military ships like aircraft carriers, super tankers, novel manufacturing techniques for boats, current research into improving aspects of boat technology, etc. This type of content helps the person to become engaged with their own project to create or design their new boat.

In another example, the computing system detects that the person is sad or angry (block 1307) while engaged in the creative process. At block 1308, in response, the computing system biases or modifies the search queries to reveal content that is considered fun or happy, or both, for the person. For example, a person's creative project is to create or design a new boat and the computing system detects that the person is sad or angry. In response, the computing system searches for content that is biased towards being fun or happy. For example, the content provided back to the person includes images, videos, audio data of people being happy on boats and people being funny on boats. The content could include jokes involving boats. The revealed content could include funny images or cartoons of boats. The content could include pictures or videos of the person on a boat being happy (e.g. smiling or laughing). This type of content helps the person to feel positive (e.g. content, peaceful, happy, humorous, etc.) about their project and, thus, helps the person to become engaged with their own project to create or design their new boat.

In another example embodiment, either in alternative or in combination with the biasing or modification of the queries, the computing system generates content according to certain conditions. For example, if the person is detected to be sad or angry, the computing system modifies existing images of boats so that all the colors are bright colors (e.g. bright yellows, blues, oranges, greens, etc.).

It will be appreciated that other rules in relation to the person's behavior or the person's environment can be used to trigger or initiate certain data processes. These data processes could bias or modify the search queries, or affect the generation of feedback data, or both.

In another example embodiment, the computing system post-processes images that have been returned from the search process. For example, the images are inverted, re-colored, shown in a collage format, shown in a timeline, edited to remove portions of the image, etc.

In an example embodiment, the computing system generates search queries based on opposite concepts. For example, if the person's creative work project is on sports cars or racecars, the related concept or tag is “fast”. The computing system generates search queries for images that relate to the concept “fast”. In addition, to generate contrast and creativity, the computing system generates search queries for images that relate to the concept “slow”.

In another example embodiment, the computing system automatically generates a historical view of the person's creative process and at certain times outputs this historical view. This historical view, for example, could be in the form of a collage of images or a visualized timeline, or is in some other format (e.g. audio only, text only, etc.). The historical view includes a summary of the concepts, emotions, objects, and results of the person's creative process so far. The historical view includes, for example, concepts and feedback data that were considered successful or positively received by the person, as well as concepts and feedback data that were considered unsuccessful or were ignored by the person. In another example aspect, the computing system also uses machine learning to generate suggestions and to overlay suggestions with the outputted historical view.

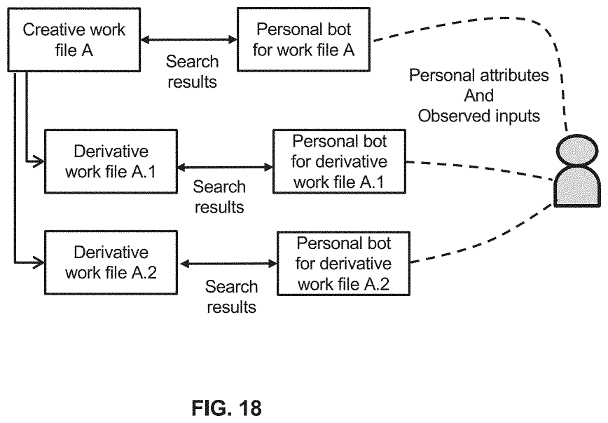

Turning to FIG. 18, it will be appreciated that multiple derivative work files A.1 and A.2 and so forth store data that is data linked to the parent creative work file A. Personal bots for the work file A, the work file A.1 and the work file A.2 operate concurrently with each other to search for data, filter the data, and store these filtered data as search results into the respective work files. These personal bots, for example, are based on the personal attributes of the user (e.g. their behavior, their culture, their interests, etc.). These personal bots also use the observed inputs of the user to dynamically adjust their search terms, and launch new search queries; the new search results are respectively stored in the work file A, the work file A.1, and the work file A.2.

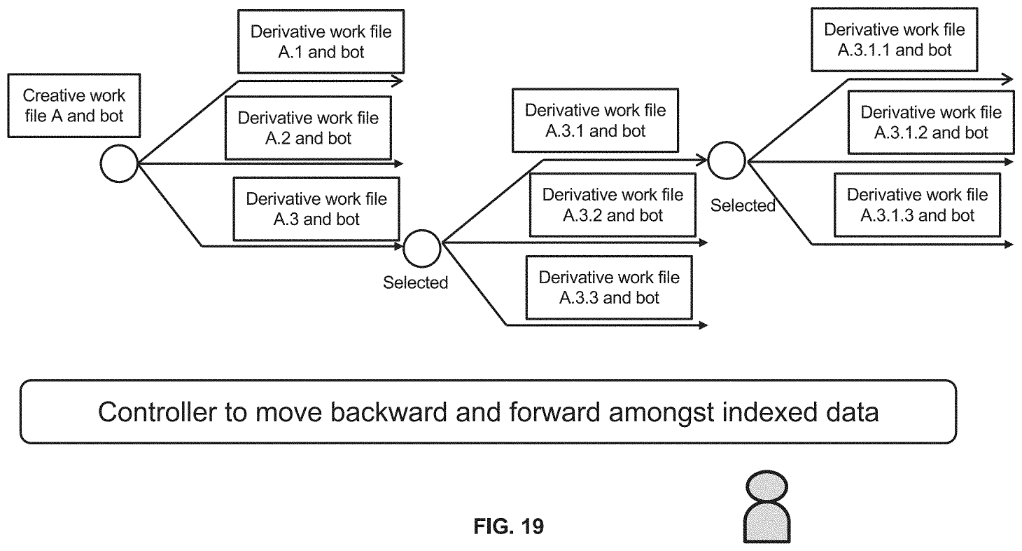

FIG. 19 shows a parent creative work file A and its respective search bot, and multiple layers of derivative work files and their bots. For example, a bot generates derivative work files A.1, A.2 and A.3 and initializes search bots for the same. A user sees or hears the search results for these work files, and selects work file A.3. This triggers another layer of derivative work files and initialization of search bots for the same: work file A.3.1; work file A.3.2; and work file A.3.3.

A controller, which is accessible via visual display, gestures, voice input, graphical user interface, etc., facilitates a user to move back and forth between the derivative work files. After exploring the derivatives search results based off work file A.3, for example, the user can change their mind and explore the derivative search results based off work file A.1. The user is able to explore different paths of thinking, going back and forth along different alternatives, which are stored and indexed.

In a further example aspect of FIG. 19, the bots for each of the derivative work files continuously conduct searches in parallel to each other, based on the inputs and actions detected of the user.

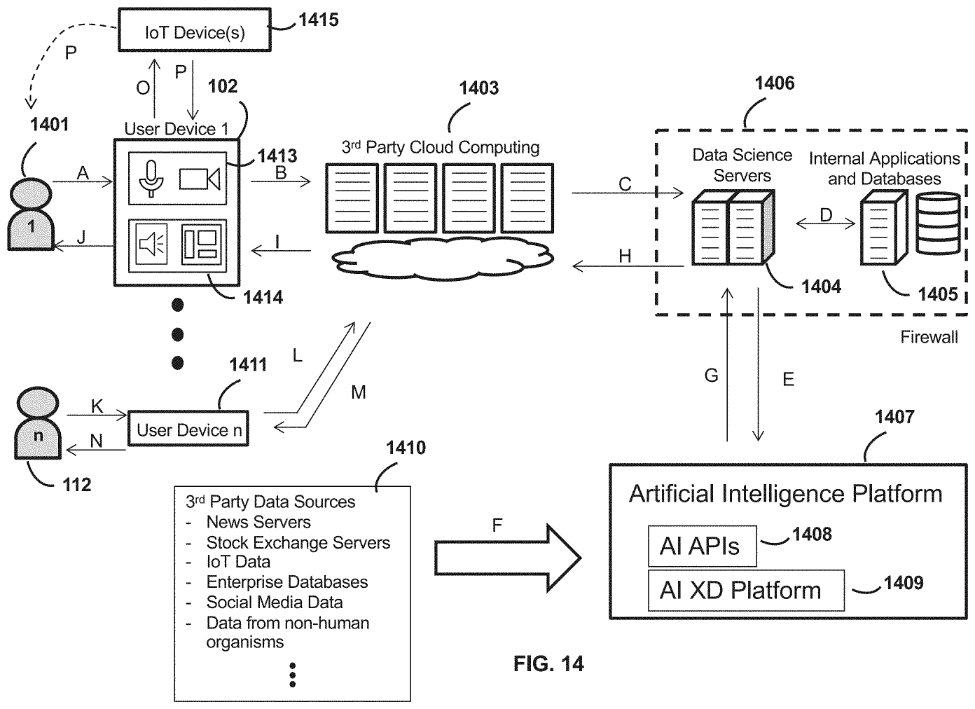

Turning to FIG. 14, a more detailed example embodiment of a computing architecture is provided for implementing the computing system. It is appreciated that this computing architecture is an example embodiment, and that other example computing architectures could be applied to the principles described herein.

In FIG. 14, a user device 102 interacts with a user 1401. The user device 102 includes, amongst other things, input devices 1413 and output devices 1414. The input devices include, for example, one or more microphones and one or more cameras. The output devices include, for example, one or more audio speakers, one or more multimedia projectors, one more display screens, etc. Non-limiting examples of user devices include a mobile phone, a smart phone, a tablet, a desktop computer, a laptop, an e-book, an in-car computer interface, wearable devices, augmented reality devices, and virtual reality devices. The user device is in communication with a 3^{rd} party cloud computing service 1403, which typically includes banks of server machines. Multiple user devices 1411 (e.g. also called a smart device, an oral communication device, an intelligent edge node, an edge device, an intelligent edge device, etc.), which correspond to multiple users 1412, can communicate with the 3^{rd} party cloud computing service 1403.

The cloud computing service 1403 is in data communication with one or more data science server machines 1404. These one or more data science server machines are in communication with internal application and databases 1405, which can reside on separate server machines, or, in another example embodiment, on the data science server machines. In an example embodiment, the data science computations executed by the data science servers and the internal applications and the internal databases are considered proprietary to given organization, and therefore are protected by a firewall 1406. Currently known firewall hardware and software systems, as well as future known firewall systems can be used.

In an alternative example, the data science servers 1404 and the databases 1405 are not protected by a firewall.

The data science server machines, also called data science servers, 1404 are in communication with an artificial intelligence (AI) platform 1407. The AI platform 1407 includes one or more AI application programming interfaces (APIs) 1408 and an AI extreme data (XD) platform 1409. As will be discussed later, the AI platform runs different types of machine learning algorithms suited for different functions, and these algorithms can be utilized and accessed by the data science servers 1404 via an AI API.

The AI platform also is connected to various data sources 1410, which may be 3^{rd} party data sources or internal data sources, or both. Non-limiting examples of these various data sources include: news servers, stock exchange servers, IoT data, enterprise databases, social media data, Internet search engines, etc. In an example embodiment, the AI XD platform 1409 ingests and processes the different types of data from the various data sources.

In an example embodiment, the network of the servers 1403, 1404, 1405, 1407 and optionally 1410 make up a data enablement platform 109. The data enablement platform provides relevant to data to the user devices, amongst other things. In an example embodiment, all of the servers 1403, 1404, 1405 and 1407 reside on cloud servers.

The data science servers include, for example, data science libraries, such as the family of STRIPA algorithms. Categories corresponding to the STRIPA methodology can be used to classify specific types of data or decision science to related classes, including for example Surface algos, Trend algos, Recommend algos, Infer algos, Predict algos, and Action algos. Surface algos, as used herein, generally refer to data science that autonomously highlights anomalies and/or early new trends. Trend algos, as used herein, generally refer to data science that autonomously performs aggregation analysis or related analysis. Recommend algos, as used herein, generally refer to data science that autonomously combines data, metadata, and results from other data science in order to make a specific autonomous recommendation and/or take autonomous actions for a system, user, and/or application. Infer algos, as used herein, generally refer to data science that autonomously combines data, metadata, and results from other data science in order to characterize a person, place, object, event, time, etc. Predict algos, as used herein, generally refer to data science that autonomously combines data, metadata, and results from other data science in order to forecast and predict a person, place, object, event, time, and/or possible outcome, etc. Action algos, as used herein, generally refer to data science that autonomously combines data, metadata, and results from other data science in order to initiate and execute an autonomous decision and/or action.

Non-limiting examples of other data science algorithms that are in the data science library include: Word2vec Representation Learning; Sentiment (e.g. multi-modal, aspect, contextual, etc.); Negation cue, scope detection; Topic classification; TF-IDF Feature Vector; Entity Extraction; Document summary; Pagerank; Modularity; Induced subgraph; Bi-graph propagation; Label propagation for inference; Breadth First Search; Eigen-centrality, in/out-degree; Monte Carlo Markov Chain (MCMC) simulation on GPU; Deep Learning with region based convolutional neural networks (R-CNN); Torch, Caffe, Torch on GPU; Logo detection; ImageNet, GoogleNet object detection; SIFT, SegNet Regions of interest; Sequence Learning for combined NLP & Image; K-means, Hierarchical Clustering; Decision Trees; Linear, Logistic regression; Affinity Association rules; Naive Bayes; Support Vector Machine (SVM); Trend time series; Burst anomaly detection; KNN classifier; Language Detection; Surface contextual Sentiment, Trend, Recommendation; Emerging Trends; Whats Unique Finder; Real-time event Trends; Trend Insights; Related Query Suggestions; Entity Relationship Graph of Users, products, brands, companies; Entity Inference: Geo, Age, Gender, Demog, etc.; Topic classification; Aspect based NLP (Word2Vec, NLP query, etc.); Analytics and reporting; Video & audio recognition; Intent prediction; Optimal path to result; Attribution based optimization; Search and finding; and Network based optimization.

An example of operations is provided with respect to FIG. 14, using the alphabetic references. At operation A, the user device 102 receives input from the user 1401. For example, the user is speaking and the user device records the audio data (e.g. voice data) from the user. While audio data is used in this example, it is appreciated that other types of input data or sensor data, or both, could be captured, transmitted and processed.

At operation B, the user device transmits the recorded audio data to the 3^{rd} party cloud computing servers 1403. In an example embodiment, the user device also transmits other data to the servers 1403, such as contextual data (e.g. time that the message was recorded, information about the user, data from surrounding IoT devices, etc.). For example, IoT devices 1415 include wearable devices (e.g. hear rate monitor, step counter), home monitoring devices, environmental monitoring devices, sensors, robotic devices, manufacturing devices (e.g. a 3D printer), etc. These servers 1403 apply machine intelligence, including artificial intelligence, to extract data features from the audio data and, if available, the contextual data. These data features include, amongst other things: text, sentiment, emotion, background noise, a command or query, or metadata regarding the storage or usage, or both, of the recorded data, or combinations thereof.

At operation C, the servers 1403 send the extracted data features and the contextual data to the data science servers 1404. In an example embodiment, the servers 1403 also send the original recorded audio data to the data science servers 1404 for additional processing.

At operation D, the data science servers 1404 interact with the internal applications and databases 1405 to process the received data. In particular, the data science servers store and executed one or more various data science algorithms to process the received data (from operation C), which may include processing data and algorithms obtained from the internal applications and the databases 1405.

In alternative, or in addition to operation D, the data science servers 1404 interact with the AI platform 1407 at operations E and G. In an example embodiment, the data science servers 1404 have algorithms that process the received data, and these algorithms transmit information to the AI platform for processing (e.g. operation E). The information transmitted to the AI platform can include: a portion or all of the data received by the data science servers at operation C; data obtained from internal applications and databases at operation D; results obtained by the data science servers from processing the received data at operation C, or processing the received data at operation D, or both; or a combination thereof. In turn, the AI platform 1407 processes the data received at operation E, which includes processing the information ingested from various data sources 1410 at operation F. Subsequently, the AI platform 1407 returns the results of its AI processing to the data science servers in operation G.

Based on the results received by the data science servers 1404 at operation G, the data science servers 1404, for example, updates its internal applications and databases 1405 (operation D) or its own memory and data science algorithms, or both. The data science servers 1404 also provide an output of information to the 3^{rd} party cloud computing servers 1404 at operation H. This outputted information may be a direct reply to a query initiated by the user at operation A. In another example, either in alternative or in addition, this outputted information may include ancillary information that is either intentionally or unintentionally requested based on the received audio information at operation A. In another example, either in alternative or in addition, this outputted information includes one or more commands that are either intentionally or unintentionally initiated by received audio information at operation A. These one or more commands, for example, affect the operation or the function of the user device 102, or other user devices 1411, or IoT devices 1415, or a combination thereof.

The 3^{rd} party cloud computing servers 1404, for example, takes the data received at operation H and applies transformation to the data, so that the transformed data is suitable for output at the user device 102. For example, the servers 1404 receive text data at operation H, and then the servers 1404 transform the text data to spoken audio data. This spoken audio data is transmitted to the user device 102 at operation I, and the user device 102 then plays or outputs the audio data to the user at operation J.

In an example embodiment, at operation O, response data from the user device 102 or originating from the server 1404 is used initiate an action of the IoT devices 1415. In some examples, at operation P, an action of the IoT device 1415 affects the user 1401. For example, the outputted feedback is an image or an audio description of a car (or some other object). At operation P, the user 1401 says “I like that” in response to seeing or hearing (or both) the outputted feedback, and this statement is detected by the microphone on the user device 102. In response, the user device 102 generates a command and transmits a 3D CAD file to the IoT device 1415, which is a 3D printer, to 3D print the car that was just described. The 3D printed car is a physical model that can help the user in their creative process.

This process is repeated for various other users 1412 and their user devices 1411. For example, another user speaks into another user device at operation K, and this audio data is passed into the data enablement platform at operation L. The audio data is processed, and audio response data is received by the another user device at operation M. This audio response data is played or outputted by the another user device at operation N.

In another example embodiment, the user uses touchscreen gestures, augmented reality gestures or movements, virtual reality gestures or movements, typing, etc. to provide inputs into the user device 102 at operation A, either in addition or in alternative to the oral input. In another example embodiment, the user device 102 provides visual information (e.g. text, video, pictures) either in addition or in alternative to the audio feedback at operation J.

It is also appreciated that that the user device 102 is also equipped with onboard intelligent hardware capabilities (e.g. memory and processors) that can locally execute data science computations and AI computations. In other words, there are data science and AI computations that are executed locally on the user device 102 without contact the data enablement platform 109. In an example aspect, the data enablement platform sends updated data science and AI computations to the user device 102, so that the user device 102 can better perform local computations.

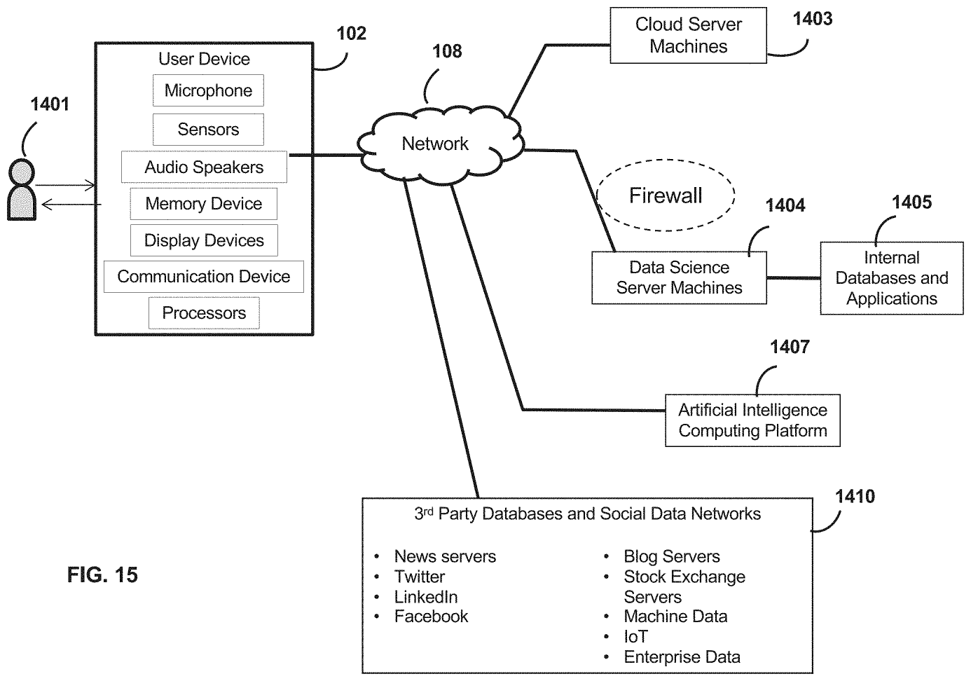

Turning to FIG. 15, another example of the servers and the devices are shown in a different data networking configuration. The user device 102, the cloud computing servers 1403, the data science servers 1404, AI computing platform 1407, and the various data sources 1410 are able to transmit and receive data via a network 108, such as the Internet. In an example embodiment, the data science servers 1404 and the internal applications and databases 1405 are in communication with each other over a private network for enhanced data security. In another example embodiment, the servers 1404 and the internal applications and the databases 1405 are in communication with each other over the same network 108.

As shown in FIG. 15, example components of the user device 102 include one or more microphones, one or more other sensors (e.g. cameras, infrared sensors, etc.), audio speakers, one or more memory devices, one or more display devices, a communication device, and one or more processors. The memory devices include, for example, RAM and ROM. The processors, for example, include one or more of: single core processors, multi-core processors, graphic processing units (GPUs), tensor processing units (TPUs), and neuromorphic chips. In an example embodiment, the one or more processors include a quantum processor, which can be used for various applications, including for executing data encryption and decryption computations to protect the user's data.

In an example embodiment, the user device's memory includes various “bots” that are part of the data enable application, which can also reside on the user device. In an example aspect, the one or more bots are considered chat bots or electronic agents. These bots include processing that also resides on the 3^{rd} party cloud computing servers 1403. Examples of chat bot technologies that can be modified or integrated (or both) into the system described herein include, but are not limited to, the trade names Siri, Google Assistant, Alexa, and Cortana. In an example aspect, the bot used herein has various language dictionaries that are focused on various topics (e.g. including, but not limited to, common family topics of a given person with dementia, common daily activities of a given person with dementia, common healthcare terms relevant to a person with dementia, etc.). In an example aspect, the bot used herein is configured to understand questions and answers specific to these various topics.

In an example aspect, the bot used herein learns the unique voice of the user, which the bot consequently uses to learn behavior that may be specific to the user. This anticipated behavior in turn is used by the data enablement platform to anticipate future questions and answers related to a given topic. This identified behavior is also used, for example, to make action recommendations to help the user achieve a result, and these action recommendations are based on the identified behaviors (e.g. identified via machine learning) of successful users in the same industry.

In an example aspect, the bot applies machine learning to identify unique data features in the user voice. Machine learning can include, deep learning. Currently known and future known algorithms for extracting voice features are applicable to the principles described herein. Non-limiting examples of voice data features, also herein called audio voice attributes, include one or more of: tone, frequency (e.g. also called timbre), loudness, rate at which a word or phrase is said (e.g. also called tempo), phonetic pronunciation, lexicon (e.g. choice of words), syntax (e.g. choice of sentence structure), articulation (e.g. clarity of pronounciation), rhythm (e.g. patterns of long and short syllables), melody (e.g. ups and downs in voice), vowel duration, peak vocal sound pressure (e.g. measured in SPL), continuity of phonation, tremor, pitch variability, and loudness variability. As noted above, these data features or audio voice attributes can be used to identify behaviors and meanings of the user, and to predict the content, behavior and meaning of the user in the future. It will be appreciated that prediction operations in machine learning include computing data values that represent certain predicted features (e.g. related to content, behavior, meaning, action, etc.) with corresponding likelihood values.

The user device may additionally or alternatively receive video data or image data, or both, from the user, and transmit this data via a bot to the data enablement platform. The data enablement platform is therefore configured to apply different types of machine learning to extract data features from different types of received data. For example, the 3^{rd} party cloud computing servers use natural language processing (NLP) algorithms or deep neural networks, or both, to process voice and text data. In another example, the 3^{rd} party cloud computing servers use machine vision, or deep neural networks, or both, to process video and image data. As noted above, these computations can also occur locally on the user device.

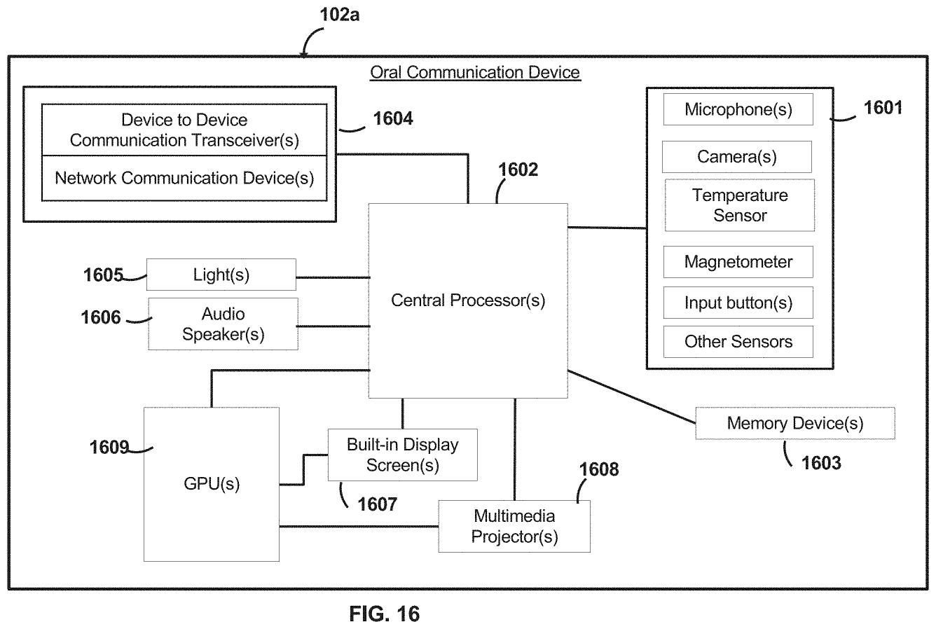

Turning to FIG. 16, an example embodiment of user device 102a is provided, that is herein also referred to as an oral communication device (OCD). The OCD 102a can be used in combination with other user devices, such as smartphones or laptops, or can be used on its own. In other words, the OCD 102a is an embodiment of the user device 102, and the OCD 102a can be used in the embodiments described herein.

Example components that are housed within the OCD 102a are shown. The components include one or more central processors 1602 that exchange data with various other components, such as sensors 1601. The sensors 1601 include, for example, one or more microphones, one or more cameras, a temperature sensor, a magnetometer, one or more input buttons, LiDAR, SONAR, RADAR, and other sensors. In an example embodiment, the LiDAR is used to build a point cloud of the surroundings around the OCD 102a. The LiDAR is also used, for example, to track the position of a person moving in the surroundings. The one or more processors 1602 include one or more of: central processing units, ASICs (application specific integrated circuits), DSP chips (digital signal processing chips), FPGAs (field programmable gate arrays), GPUs (graphic processing units), TPUs (tensor processing units), and neuromorphic chips. Other currently known and future known processors can be used in the OCD.

In an example embodiment, there are multiple microphones that are oriented to face in different directions from each other. In this way, the relative direction or relative position of an audio source can be determined. In another example embodiment, there are multiple microphones that are tuned or set to record audio waves at different frequency ranges (e.g. a microphone for a first frequency range, a microphone for a second frequency range, a microphone for a third frequency range, etc.). In this way, more definition of audio data can be recorded across a larger frequency range.

In an example embodiment, there are multiple cameras that are oriented to face in different directions. In this way, the OCD can obtain a 360 degree visual field of view. In another example, one or more cameras have a first field of a view with a first resolution and one or more cameras have a second field of view with a second resolution, where the first field of view is larger than the second field of view and the first resolution is lower than the second resolution. In a further example aspect, the one or more cameras with the second field of view and the second resolution can be mechanically oriented (e.g. pitched, yawed, etc.) while the one or more cameras with the first field of view and the first resolution are fixed. In this way, video and images can be simultaneously taken from a larger perspective (e.g. the surrounding area, people's bodies and their body gestures), and higher resolution video and images can be simultaneously taken for certain areas (e.g. people faces and their facial expressions).

The OCD also includes one or more memory devices 1603, lights 1605, one or more audio speakers 1606, one or more communication devices 1604, one or more built-in-display screens 1607, and one or more media projectors 1608. The OCD also includes one or more GPUs 1609. GPUs or other types of multi-threaded processors are configured for executing AI computations, such as neural network computations. The GPUs are also used, for example, to process graphics that are outputted by the multimedia projector(s) or the display screen(s) 1607, or both.

In an example embodiment, the communication devices include one or more device-to-device communication transceivers, which can be used to communicate with one or more user devices. For example, the OCD includes a Bluetooth transceiver. In another example aspect, the communication devices include one or more network communication devices that are configured to communicate with the network 108, such as a network card or WiFi transceiver, or both.

In an example embodiment, there are multiple audio speakers 1606 positioned on the OCD to face in different directions. In an example embodiment, there are multiple audio speakers that are configured to play sound at different frequency ranges.

In an example embodiment, the built-in display screen forms a curved surface around the OCD housing body. In an example embodiment, there are multiple media projectors that project light in different directions.

In an example embodiment, the OCD is able to locally pre-process voice data, video data, image data, and other data using on-board hardware and machine learning algorithms. This reduces the amount of data being transmitted to the data enablement platform 109, which reduced bandwidth consumption. This also reduces the amount of processing required by the data enablement platform.

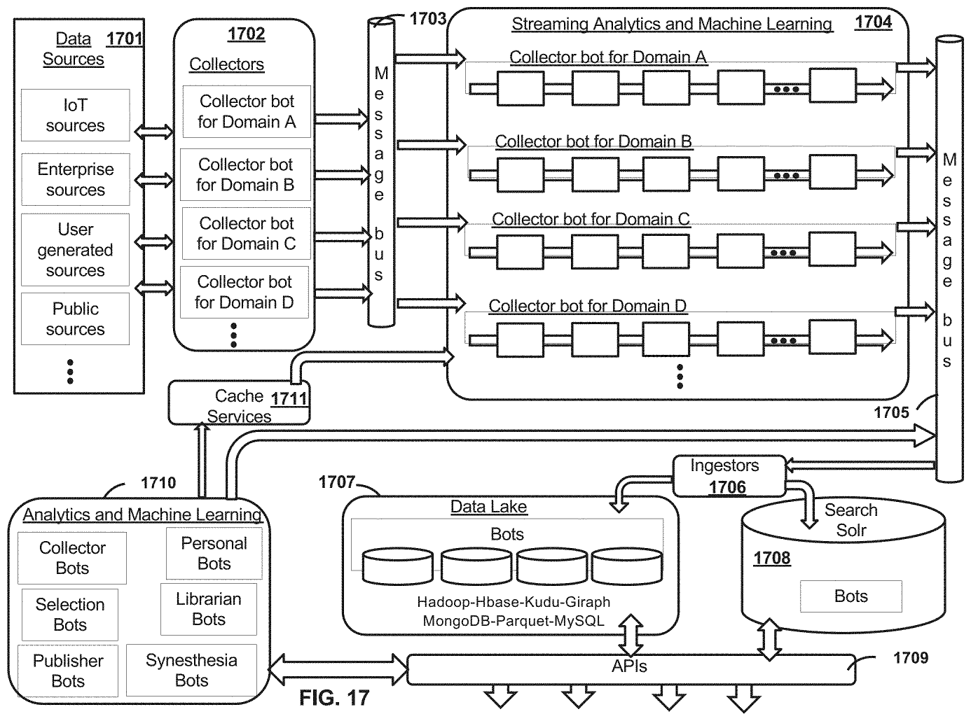

FIG. 17 shows an example embodiment of a software architecture of the data enablement platform 109, which can be incorporated into the above computing systems.

In FIG. 17, an example computing architecture is provided for collecting data and performing machine learning on the same.

The architecture in FIG. 17 includes multiple data sources 1701. For example, data sources include those that considered part of any one or more of: the IoT data sources, the enterprise data sources, the various user devices, input devices, sensors, and the public data sources (e.g. public websites and data networks).

In particular, each one of the collector bots in the data collectors module 1702 collect data specific to a certain domain (e.g. creativity domains as described with respect to FIG. 5). For example, one collector bot obtains data in relation Domain A, and another collector bot obtains data in relation to Domain B.

The collector bots operate in parallel to generate parallel streams or threads of collected data. The collected data is transmitted via a message bus 1703 to a distributed streaming analytics engine 1704, which applies various data transforms and machine learning algorithms. For example, for the collector bot for Domain A, the streaming analytics engine 1704 has modules to transform the incoming video data, apply language detection, apply movement detection, add custom tags to the incoming data, detect trends, and extract objects and meaning from images and video. Other collector bots can have the same streaming analytics modules, or different ones. For example, another collector bot has a Surfacing analytics module, a Trend detector analytics module, Recommend analytics module, an Inference analytics module, a Predict analytics module, and an Action analytics module (collectively called STRIPA). It can be appreciated that different data sources require different reformatting protocols. Each collector bot processes its data using streaming analytics in parallel to the other search bots. This continued parallelized processing by the collector bots allows for the data enablement platform to process large amounts of data from different data sources in real time, or near real time.

In an example implementation, the engine 1704 is structured using one or more of the following big data computing approaches: NiFi, Spark and TensorFlow.

NiFi automates and manages the flow of data between systems. More particularly, it is a real-time integrated data logistics platform that manages the flow of data from any source to any location. NiFi is data source agnostic and supports different and distributes sources of different formats, schemas, protocols, speeds and sizes. In an example implementation, NiFi operates within a Java Virtual Machine architecture and includes a flow controller, NiFi extensions, a content repository, a flowfile repository, and a provenance repository.

Spark, also called Apache Spark, is a cluster computing framework for big data. One of the features of Spark is Spark Streaming, which performs streaming analytics. It ingests data in mini batches and performs resilient distributed dataset (RDD) transformations on these mini batches of data.

TensorFlow is software library for machine intelligence developed by Google. It uses neural networks which operate on multiple central processing units (CPUs), GPUs and tensor processing units (TPUs).

Analytics and machine learning modules 1710 are also provided to ingest larger volumes of data that have been gathered over a longer period of time (e.g. from the data lake 1707). In particular, collector bots obtain user interaction data to set parameters for filtering or processing algorithms, or to altogether select filtering or processing algorithms from an algorithms library. The collector bots, for example, use one or more of the following data science modules to extract classifications from the collected data: an inference module, a sessionization module, a modeling module, a data mining module, and a deep learning module. These modules can also, for example, be implemented by NiFi, Spark or TensorFlow, or combinations thereof. In an example embodiment, unlike the modules in the streaming analytics engine 1704, the computations done by the modules 1710 are not streaming. In particular, the computations of any one or more of the collector bots, personal bots, selection bots, publisher bots, synesthesia bots, and librarian bots are part of the modules 1710. The results outputted by the modules 1710 are stored in memory (e.g. cache services 1711), which then transmitted to the streaming analytics engine 1704.

The results outputted by the streaming analytics engine 1704, are transmitted to ingestors 1706, via the message bus 1705. The outputted data from the analytics and machine learning modules 1710 are also transmitted to the ingestors 1706 via the message bus 1705.

The ingestors 1706 organize and store the data into the data lake 1707, which comprise massive database frameworks. Non-limiting examples of these database frameworks include Hadoop, HBase, Kudu, Giraph, MongoDB, Parquet and MySQL. The data outputted from the ingestors 1706 may also be inputted into a search platform 1708. A non-limiting example of the search platform 1708 is the Solr search platform built on Apache Lucene. The Solr search platform, for example, provides distributed indexing, load balanced querying, and automated failover and recovery.

Data from the data lake and the search engine are accessible by API services 1709.

In an example embodiment, the data enablement platform 109 and the user edge nodes generate immutable data. For example, the inputted data and the outputted data are stored on a distributed ledger (e.g. a blockchain, ledgerless blockchain, or other immutable data protocol), which is stored across the multiple edge nodes.

In another example embodiment, an intelligent edge node device (e.g. a user device), is provided that includes: memory that stores data science algorithms and local data that is first created directly or indirectly by the intelligent edge node device; one or more processors that are configured to at least perform localized decision science using the data science algorithms to process the local data; and a communication device. The communication device communicates with other intelligent edge node devices in relation to one or more of: the data science algorithms, the processing of the local data, and an anomalous result pertaining to the local data.

In an example aspect, the one or more processors (e.g. including system on chips (SOCs)) convert the local data to microcode and the communication device transmits the microcode to the other intelligent edge node devices. In another example aspect, the one or more processors convert the one or more data science algorithms to microcode and the communication device transmits the microcode to the other intelligent edge node devices. In another example aspect, the communication device receives microcode and the one or more processors perform local autonomous actions utilizing the microcode, wherein the microcode is at least one of new data and a new data science algorithm. In another example aspect, the memory or the one or more processors, or both, are flashable with one or more new data science algorithms. In another example aspect, the memory stores an immutable ledger that is distributed on the intelligent edge node device and the other intelligent edge node devices. In another example aspect, the local data is biological-related data (e.g. user biometric data, brain signals, etc.) that is stored on the immutable ledger.

In a general example embodiment, a computing system is provided for human creativity co-computing. The computing system includes: a memory system that stores thereon a first creative data file; an input device system that monitors and records human inputs that are stored in the first creative data file; a processor system that processes the human inputs to generate search terms that at least one of support and contrast the human inputs, and that initiates autonomous searching using the search terms to obtain search results, the search results automatically stored in the first creative data file; and an output device system that outputs the search results. The input device system is further configured to monitor subsequent human inputs that are responsive to the outputted search results, and the processor system automatically generates a second creative data file in the memory system that is data linked as a derivative of the first creative data file. The processor system stores the subsequent human inputs into the second creative data file. The processor system is configured to process the subsequent human inputs to generate subsequent search terms that at least one of support and contrast the subsequent human inputs, initiate autonomous searching using the subsequent search terms to obtain subsequent search results, compute filtered subsequent search results by deleting data from the subsequent search results that match any one or more of the search results stored in the first creative data file, and store the filtered subsequent search results in the second creative data file. The output device system is configured to further output the filtered subsequent search results.

In an example aspect, while the processor system generates the search terms and obtains the search results, the input device system simultaneously continues to monitor and record the human inputs for storage in the first creative data file.

In another example aspect, the input device system includes a camera and the human inputs and the subsequent human inputs include at least one of: body posture, body movement, writing, drawing, hand movement, human-and-object interaction, and facial expression.

In another example aspect, the input device system includes a microphone and the human inputs and the subsequent human inputs include at least one of: talking, sighs, crying, singing, and music.

In another example aspect, the input device system includes a brain computer interface and the human inputs and the subsequent human inputs include at least one of: brain signals, nerve signals, and muscle signals.

In another example aspect, the input device system includes a camera and a microphone, and the human inputs and the subsequent human inputs include: body posture and talking.

In another example aspect, the input device system includes a camera and a microphone, and the human inputs and the subsequent human inputs include: facial expressions and talking.

In another example aspect, the subsequent human inputs that are responsive to the outputted search results are indexed as behavior metadata, and the indexed behavior metadata data links together the search results stored in the first creative data file and the filtered subsequent search results stored in the second creative data file.

In another example aspect, the search results and the filtered subsequent search results include one or more of: text, pictures, video data, and audio data.

In another example aspect, the input device system further records environment data about an environment of a human providing the human inputs, and the processor system uses the environment data and the human inputs to generate the search terms.

In another example aspect, the environment data includes visual data about the environment.

In another example aspect, the environment data includes location data.

In another example aspect, the environment data includes audio data about the environment.

In another example aspect, the processor system includes a personal bot that is specific to a human that provides the human input, wherein the personal bot includes behavioral attributes of the human and data about a creative domain of the first creative work file and the second creative work file; and the personal bot is configured to generate search terms and subsequent search terms that are biased to the behavioral attributes and that are related to the creative domain.

In another example aspect, the input device system and the output device system are local to a human providing the human input and the subsequent human input, and the processor system and the memory system are part of a remote cloud computing platform.

In another example aspect, the processor system is configured to compute the filtered subsequent data by identifying data from the subsequent search results that are beyond one or more constraint thresholds, and delete this identified data.

In another example aspect, the processor system is further configured to identify old data from the subsequent search results that is dated older than a threshold date, are delete this old data from the subsequent search results to compute the filtered subsequent data.

In another example aspect, responsive to detecting that a human providing the human input has paused in their activity, the output device system outputting the search results.

In another example aspect, outputting the search results is deferred while detecting that a human providing the human input is continuing their activity.

In another example aspect, the input device system and the output device system are part of a wearable device.

In another example aspect, the output device system includes a multimedia projector.

In another example aspect, the input device system and the output device system are part of an oral communication device that is local to a human providing the human inputs and the subsequent human inputs, and the memory system and the processor system are part of a remote cloud computing platform; and the oral communication device is in data communication with the remote cloud computing platform.

In another example aspect, the input device system includes a camera and a microphone, and the output device system includes an audio speaker and a display screen.

In another general example embodiment, a computing system for human creativity co-computing is provided. The computing system includes: a memory system that stores thereon a first creative data file; an input device system that monitors a human and records their human inputs, which are stored in the first creative data file; a processor system that processes the human inputs to generate search terms that contrast the human inputs, and that initiates autonomous searching using the search terms to obtain search results, the search results automatically stored in the first creative data file; and an output device system that outputs the search results. The input device system is further configured to record subsequent human inputs that identify a specific portion of the outputted search results and a reaction to the specific portion, and the processor system automatically generates a second creative data file in the memory system that is data linked as a derivative of the first creative data file. The processor system stores the specific portion and the reaction to the specific portion into the second creative data file. The processor system is configured to generate subsequent search terms based on the specific portion and the reaction to the specific portion, initiate autonomous searching using the subsequent search terms to obtain subsequent search results, compute filtered subsequent search results by deleting data from the subsequent search results that match any one or more of the search results stored in the first creative data file, and store the filtered subsequent search results in the second creative data file. The output device system is configured to further output the filtered subsequent search results.

It is appreciated that these computing and software architectures are for example. Other architectures can also be used to accelerate the processing of data to facilitate human creativity co-computing.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or devices or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A computing system for human creativity co-computing, the computing system comprising:
a memory system that stores thereon a first creative data file;
an input device system that monitors and records human inputs that are stored in the first creative data file;
a processor system that processes the human inputs to generate search terms that at least one of support and contrast the human inputs, and that initiates autonomous searching using the search terms to obtain search results, the search results automatically stored in the first creative data file;
an output device system that outputs the search results;
the input device system further configured to monitor subsequent human inputs that are responsive to the outputted search results, and the processor system automatically generates a second creative data file in the memory system that is data linked as a derivative of the first creative data file, and the processor system stores the subsequent human inputs into the second creative data file;
the processor system configured to process the subsequent human inputs to generate subsequent search terms that at least one of support and contrast the subsequent human inputs, initiate autonomous searching using the subsequent search terms to obtain subsequent search results, compute filtered subsequent search results by deleting data from the subsequent search results that match any one or more of the search results stored in the first creative data file, and store the filtered subsequent search results in the second creative data file; and
the output device system configured to further output the filtered subsequent search results.

2. The computing system of claim 1 wherein, while the processor system generates the search terms and obtains the search results, the input device system simultaneously continues to monitor and record the human inputs for storage in the first creative data file.

3. The computing system of claim 1 wherein the input device system comprises a camera and the human inputs and the subsequent human inputs comprise at least one of: body posture, body movement, writing, drawing, hand movement, human-and-object interaction, and facial expression.

4. The computing system of claim 1 wherein the input device system comprises a microphone and the human inputs and the subsequent human inputs comprise at least one of: talking, sighs, crying, singing, and music.

5. The computing system of claim 1 wherein the input device system comprises a brain computer interface and the human inputs and the subsequent human inputs comprise at least one of: brain signals, nerve signals, and muscle signals.

6. The computing system of claim 1 wherein the input device system comprises a camera and a microphone, and the human inputs and the subsequent human inputs comprise: body posture and talking.

7. The computing system of claim 1 wherein the input device system comprises a camera and a microphone, and the human inputs and the subsequent human inputs comprise: facial expressions and talking.

8. The computing system of claim 1 wherein the subsequent human inputs that are responsive to the outputted search results are indexed as behavior metadata, and the indexed behavior metadata data links together the search results stored in the first creative data file and the filtered subsequent search results stored in the second creative data file.

9. The computing system of claim 1 wherein the search results and the filtered subsequent search results comprise one or more of: text, pictures, video data, and audio data.

10. The computing system of claim 1 wherein the input device system further records environment data about an environment of a human providing the human inputs, and the processor system uses the environment data and the human inputs to generate the search terms.

11. The computing system of claim 10 wherein the environment data comprises visual data about the environment.

12. The computing system of claim 10 wherein the environment data comprises location data.

13. The computing system of claim 10 wherein environment data comprises audio data about the environment.

14. The computing system of claim 1 wherein the processor system comprises a personal bot that is specific to a human that provides the human input, wherein the personal bot comprises behavioral attributes of the human and data about a creative domain of the first creative work file and the second creative work file; and the personal bot is configured to generate search terms and subsequent search terms that are biased to the behavioral attributes and that are related to the creative domain.

15. The computing system of claim 1 wherein the input device system and the output device system are local to a human providing the human input and the subsequent human input, and the processor system and the memory system are part of a remote cloud computing platform.

16. The computing system of claim 1 wherein the processor system is configured to compute the filtered subsequent data by identifying data from the subsequent search results that are beyond one or more constraint thresholds, and delete this identified data.

17. The computing system of claim 16 wherein the processor system is further configured to identify old data from the subsequent search results that is dated older than a threshold date, are delete this old data from the subsequent search results to compute the filtered subsequent data.

18. The computing system of claim 1 wherein, responsive to detecting that a human providing the human input has paused in their activity, the output device system outputting the search results.

19. The computing system of claim 1 wherein, outputting the search results is deferred while detecting that a human providing the human input is continuing their activity.

20. The computing system of claim 1 wherein the input device system and the output device system are part of a wearable device.

21. The computing system of claim 1 wherein the output device system comprises a multimedia projector.

22. The computing system of claim 1 the input device system and the output device system are part of an oral communication device that is local to a human providing the human inputs and the subsequent human inputs, and the memory system and the processor system are part of a remote cloud computing platform; and the oral communication device is in data communication with the remote cloud computing platform.

23. The computing system of claim 22, wherein the input device system comprises a camera and a microphone, and the output device system comprises an audio speaker and a display screen.

24. A computing system for human creativity co-computing, the computing system comprising:
a memory system that stores thereon a first creative data file;
an input device system that monitors a human and records their human inputs, which are stored in the first creative data file;
a processor system that processes the human inputs to generate search terms that contrast the human inputs, and that initiates autonomous searching using the search terms to obtain search results, the search results automatically stored in the first creative data file;
an output device system that outputs the search results;
the input device system further configured to record subsequent human inputs that identify a specific portion of the outputted search results and a reaction to the specific portion, and the processor system automatically generates a second creative data file in the memory system that is data linked as a derivative of the first creative data file, and the processor system stores the specific portion and the reaction to the specific portion into the second creative data file;
the processor system configured to generate subsequent search terms based on the specific portion and the reaction to the specific portion, initiate autonomous searching using the subsequent search terms to obtain subsequent search results, compute filtered subsequent search results by deleting data from the subsequent search results that match any one or more of the search results stored in the first creative data file, and store the filtered subsequent search results in the second creative data file; and
the output device system configured to further output the filtered subsequent search results.
